(19) United States
(12) Patent Application Publication
(10) Pub. No.: US 2024/0386152 A1
(43) Pub. Date: Nov. 21, 2024

(54) BUILDING DESIGN SYSTEM AND USER INTERFACE

(71) Applicant: Wall to Wall, LLC, Hayward, CA (US)

(72) Inventors: Gilad ALFASI, Binyamina (IL); Ami Amiel Shai AVRAHAMI, Rehovot (IL)

(73) Assignee: Wall to Wall, LLC, Hayward, CA (US)

(21) Appl. No.: 18/666,685

(22) Filed: May 16, 2024

Related U.S. Application Data
(60) Provisional application No. 63/502,540, filed on May 16, 2023.

(51) Int. Cl. G06F 30/12; G06F 30/13

(52) U.S. Cl. CPC G06F 30/12; G06F 30/13

(57) ABSTRACT

A method of designing a building using a design system, is provided. The method comprises: displaying a user interface at a display of the design system, wherein the user interface comprises a design template, wherein the design template is configured with design requirements; receiving a selection of a first virtual building element to be incorporated into the design template; adjusting an intrinsic property of the first virtual building element based on the design requirements of the design template; identifying a second virtual building element in the design template; and based on the relationship between the first virtual building element and the identified second virtual building element, adjusting an intrinsic property of the first virtual building element such that both the first and second virtual building elements meet the design requirements of the design template.

### CROSS-REFERENCE TO RELATED APPLICATIONS

This application claims priority to and the benefit of U.S. Provisional Application No. 63/502,540, filed May 16, 2023, the entire contents of which are hereby incorporated by reference.

### FIELD

The present disclosure relates generally to building design, and more particularly to modular building design techniques and virtual design systems used to design buildings.

### BACKGROUND

Traditional linear or sequential development processes used to design buildings typically involve a series of stages, each being managed by human professionals specialized in a specific domain or field of expertise. Upon completion of a stage, the process advances to the next, and so forth. This process can be iterative, as any issues identified at a particular stage may necessitate revisiting and repeating previous stages with updated design and development information.

Automating such processes typically involves replacing human experts with software-based agents, each encapsulating the knowledge and skills of the human expert it replaces. When implementing automation for prefabricated and modular construction, introducing design variations can significantly increase the complexity of automating this process. An automation system would need to consider the manufacturability of each module, transportation constraints, and the need for all the modules to integrate seamlessly on site.

### SUMMARY

Current approaches to automated building design are often impractical due to the inherent complexity of the development process since each building will have unique design requirements and restrictions. Additionally, such a straightforward automation approach using software agents fails to adapt to changes in scope or operational scenarios, as would be required when, for example, transitioning the design of a home from a California-based market to a Washington-based market, where different climate conditions, building regulations, and market preferences apply.

Provided herein is a building design system and a user interface, as well as a method of designing a building using the design system that can address the shortcomings in current automated building design systems. The system, user interface, and method can provide for the partial or complete automation of one or more steps of a building design process without the need to replace human experts with software-based agents. Instead, the provided approach to automating a building design process involves configuring a virtual design template (i.e. a blueprint, floor plan, or skeleton) of a building with various design requirements based on restrictions related to architectural considerations, building codes, and other design requirements of the building.

By configuring the virtual design template with knowledge of various design requirements and then displaying the virtual design template on a user interface of a display, a user is able to select virtual building elements corresponding to rooms in a building, for example, to be included in the design template with the user interface. The virtual building elements can adjust various intrinsic properties of the individual element (i.e. dimensions, objects or sub-elements located within the virtual building elements, and so on) such that they comply with the design requirements. The design template (i.e. the floor plan including multiple building elements) may also adjust various extrinsic properties related to interactions between building elements (i.e. shear wall potential, aligning windows across floors, mechanical, electrical, and plumbing (MEP) routing throughout the entire building, and so on). Thus, the overall design of a building, as well as the designs of individual rooms, can be made compliant with various design requirements without the need for a user consult with experts at different stages of the design process.

Accordingly, rather than merely automating and performing the same activities at a single stage of the design process, multiple stages of the design process can be combined as the virtual building element adjusts itself to comply with the various design requirements. This can change the manner in which a building can be designed. For example, the automation of one or more parts of the building design process can allow complex design requirements to be automatically incorporated into a compliant building design without the need for many different software-based agents that are ordinarily needed to perform this capability. This can result in a design system and a user interface that are more adaptable and interactive than current design systems. Further, this can allow for multiple stages of the design process to occur simultaneously, eliminating the need for repeating steps of the design process in the event that design requirements should change, reducing costs and time spent on the design process, and improving efficiency.

In some embodiments, a method of designing a building using a design system is provided. The method may include, for example, displaying a user interface at a display, wherein the user interface comprises a design template, wherein the design template is configured with design requirements. The design requirements may include architectural requirements, mechanical, electrical, and plumbing (MEP) requirements, building codes, and/or zoning requirements. The method may include receiving a selection of a first virtual building element to be incorporated into the design template. The method may include adjusting an intrinsic property of the first virtual building clement based on the design requirements of the design template. In some embodiments, the intrinsic property comprises dimensions, positioning, and/or sub-elements located within the first virtual building clement. In some embodiments, the method includes identifying a second virtual building element in the design template. Based on the relationship between the first virtual building clement and the identified second virtual building element, the method can include adjusting an intrinsic property of the first virtual building element such that both the first and second virtual building elements meet the design requirements of the design template.

In some embodiments, adjusting an intrinsic property of the first virtual building element comprises resizing the first virtual building element, rotating the first virtual building element, adding, removing, and/or changing a location of a sub-element within the first virtual building element, or combinations thereof.

In some embodiments, the method comprises adjusting an intrinsic property of the second virtual building element such that both the first and second virtual building elements meet the design requirements.

In some embodiments, adjusting an intrinsic property of the second virtual building element comprises resizing the second virtual building element, rotating the second virtual building clement, adding, removing, and/or changing a location of a sub-element within the second virtual building element, or combinations thereof.

In some embodiments, the sub-element comprises a window, a wall, a door, an MEP component, a modular building element located within the first or second virtual building element, or combinations thereof.

In some embodiments, the MEP component comprises an HVAC component, a plumbing component, an electrical component, a data component, or combinations thereof.

In some embodiments, the first or second virtual building element comprises a bedroom, a kitchen, a living room, a dining room, a bathroom, a basement, a corridor, a garage, or combinations thereof.

In some embodiments, the method comprises adjusting an extrinsic property of the design template to meet the design requirements, wherein the extrinsic property comprises a shear wall potential, an MEP system, an overall layout of multiple virtual building elements in the design template, or combinations thereof.

In some embodiments, adjusting the extrinsic property comprises aligning windows, adjusting MEP routing, or changing an overall layout of multiple virtual building elements in the design template.

In some embodiments, the design template is a floor plan, a blueprint, and/or a skeleton of a house, a building, or a neighborhood.

In some embodiments, the method comprises constructing the building based on the design template.

In some embodiments, a design system is provided, the design system comprising a display; one or more processors; and memory storing instructions configured to be executed by the one or more processors. In some embodiments, the instructions may cause the design system to: display a user interface, wherein the user interface comprises a design template, wherein the design template is configured with design requirements comprising architectural requirements, mechanical, electrical, and plumbing (MEP) requirements, building codes, and/or zoning requirements. In some embodiments, the system may be caused to receive a selection of a first virtual building element to be incorporated into the design template. In some embodiments, the system may be caused to adjust an intrinsic property of the first virtual building element based on the design requirements of the design template. In some embodiments, the intrinsic property comprises dimensions, positioning, and/or sub-elements located within the first virtual building element. In some embodiments, the system may be caused to identify a second virtual building element in the design template. In some embodiments, based on the relationship between the first virtual building element and the identified second virtual building element, adjust an intrinsic property of the first virtual building clement such that both the first and second virtual building elements meet the design requirements of the design template.

In some embodiments, adjusting an intrinsic property of the first building element comprises resizing the first virtual building element, rotating the first virtual building element, adding, removing, and/or changing a location of a sub-element within the first virtual building clement, or combinations thereof.

In some embodiments, the system may be caused to adjust an intrinsic property of the second virtual building element such that both the first and second virtual building elements meet the design requirements.

In some embodiments, an intrinsic property of the second virtual building element comprises resizing the second virtual building element, rotating the second virtual building clement, adding, removing, and/or changing a location of a sub-element within the second virtual building element, or combinations thereof.

In some embodiments, the sub-elements comprise a window, a wall, a door, an MEP component, a modular building clement located within the first or second building element, or combinations thereof.

In some embodiments, the MEP component comprises an HVAC component, a plumbing component, an electrical component, a data component, or combinations thereof.

In some embodiments, the first or second virtual building element comprises a bedroom, a kitchen, a living room, a dining room, a bathroom, a basement, a corridor, a garage, or combinations thereof.

In some embodiments, the system may be caused to adjust an extrinsic property of the design template to meet the design requirements, wherein the extrinsic property comprises a shear wall potential, an MEP system, an overall layout of virtual building elements in the design template, or combinations thereof.

In some embodiments, adjusting the extrinsic property comprises aligning windows, adjusting MEP routing, or changing an overall layout of virtual building elements in the design template.

In some embodiments, the design template is a blueprint, a floor plan, and/or a skeleton of a house, a building, or a neighborhood.

In some embodiments, a non-transitory computer readable storage medium storing one or more programs is provided. The one or more programs may comprise instructions, which, when executed by a design system, cause the design system to: display a user interface at a display, wherein the user interface comprises a design template. In some embodiments, the design template is configured with design requirements comprising architectural requirements, mechanical, electrical, and plumbing (MEP) requirements, building codes, and/or zoning requirements. In some embodiments, the design system may be caused to receive a selection of a first virtual building element to be incorporated into the design template. In some embodiments, the design system may be caused to adjust an intrinsic property of the first virtual building element based on the design requirements of the design template. The intrinsic property may comprise dimensions, positioning, and/or sub-elements located within the first virtual building element. In some embodiments, the system may be caused to identify a second virtual building element in the design template. Based on the relationship between the first virtual building element and the identified second virtual building element, the system may be caused to adjust an intrinsic property of the first virtual building element such that both the first and second virtual building elements meet the design requirements of the design template.

In some embodiments, provided is a system for automating modular construction design, the system comprising: intelligent building blocks (i.e. virtual building elements) that can possess both intrinsic and extrinsic functionalities, each building block having a baseline format that can include dimensions, other elements included in the space, and relational restrictions when positioning these elements.

Each building block (i.e. virtual building element) may include intrinsic transformation operations such as resize, rotate, and so on.

Each building block (i.e. virtual building element) may include additional transformation guidelines, such as anchor points for resizing or the effects of rotation on room elements.

Each building block (i.e. virtual building element) may include extrinsic relationship functions when neighboring other building blocks. In addition, the building blocks can adapt their design attributes and relationships based on various factors, including design variations and changes in regulations.

The automation process can reduce the need for a linear development process and its associated complexities by focusing on the intelligent design of the building blocks themselves.

The system can automate a design process in the modular construction industry, comprising a plurality of sentient building blocks (i.e. virtual building elements), each building block being capable of adjusting and adapting its own behavior to specific environment conditions of a design case, managing both intrinsic functions and interactions with other building blocks, and being capable of interacting with other building blocks.

The system's building blocks (i.e. virtual building elements) can represent a specific class of space within a home, building, or neighborhood, including but not limited to bedrooms, kitchens, living rooms, corridors, and garages.

The system's building blocks (i.e. virtual building elements) can possess specific functions and attributes related to architectural design considerations, structural engineering, and MEP (Mechanical, Electrical, Plumbing) system design guidelines, including functions and attributes dedicated for the inter-relationships between the building blocks.

The building blocks (i.e. virtual building elements) can be capable of resizing themselves while preserving certain aspects of a base design, and can be capable of connecting with other building blocks while preserving for example, exterior wall, window positioning, relative door positioning, etc. Each building block can be capable of accounting for external and internal walls and other collisions when connecting with other building blocks.

The building blocks (i.e. virtual building elements) across different floors can be capable of re-aligning windows to preserve aesthetics and maximize shear wall potential.

The building blocks (i.e. virtual building elements) can be capable of detecting and adjusting to MEP considerations, specifically plumbing pipe routing, detecting electrical components within the block and following planned connections between spaces for routing.

Each building block (i.e. virtual building element) can be capable of calculating (sensing and measuring) inter-relationships between each other, and identifying possible missed spaces or extra spaces (voids).

The home itself can be considered a building block (i.e. a virtual building element) with additional aspects related to window alignment, plumbing route planning, analytical modeling, program cost, and city regulations and rights.

The sentient building blocks (i.e. virtual building elements) can be organized in a way to include architectural organization, auto-completion, and coordination; MEP considerations including plumbing points, electricity, and air conditioning; real estate design guidelines and quantities; and structural engineering considerations including structural integrity, load, and span.

The sentient building blocks (i.e. virtual building elements) can be programmed using an object-oriented approach, including both intra and inter-related functions to manage their individual functionality and interactions with other blocks.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 shows a diagram of a linear (sequential) design (or development) process, according to some embodiments.

FIG. 2 shows the diagram from Fig. 1 adapted for building design processes, according to some embodiments.

FIG. 3 shows the diagram from FIG. 2 with possible iterations and repetitions of steps, according to some embodiments.

FIG. 4 shows automation of a building design process, according to some embodiments.

FIG. 5 shows an overview of an automated building design process, according to some embodiments.

FIG. 6 illustrates object-oriented programming, according to some embodiments.

FIG. 7 illustrates object-oriented programming, according to some embodiments.

FIG. 8 illustrates object-oriented programming as applied to a virtual design template, according to some embodiments.

FIG. 9A illustrates a virtual building element, according to some embodiments.

FIG. 9B demonstrates an intrinsic operation being performed on a virtual building element, according to some embodiments.

FIGS. 10A-10C illustrate the pairing of a plurality of virtual building elements, according to some embodiments.

FIGS. 11A-11B illustrate a plurality of 3D virtual building elements, according to some embodiments.

FIGS. 12A-12C illustrate the alignment of windows of a building design to maximize shear wall potential, according to some embodiments.

FIGS. 13A-13C show exemplary mechanical, electrical, and plumbing (MEP) considerations, according to some embodiments.

FIGS. 14A-14B show additional exemplary MEP considerations, according to some embodiments.

FIGS. 15A-15B demonstrate the adjustment of extrinsic properties of a design template, according to some embodiments.

FIG. 16 illustrates an exemplary building design system and user interface, according to some embodiments.

FIG. 17 illustrates an exemplary method for designing a building using a building design system, according to some embodiments.

FIG. 18 illustrates a computer, according to some embodiments.

FIG. 19A-19D illustrate exemplary user interfaces, according to some embodiments.

### DETAILED DESCRIPTION

Described herein are methods and systems that can be used for designing a building (with a user interface). The building may be a modular building and may be for residential or commercial use. Methods of designing a building using a design system (with a displayed user interface) are also provided. In some embodiments, the user interface may include a design system or design template of the system that is configured or programmed with one or more design requirements that are specific to the building. For example, the design requirements may include architectural requirements, mechanical, electrical, and plumbing (MEP) requirements, building codes, or zoning requirements.

At the user interface, a user may select a virtual building element to be incorporated into the design template. The virtual building element may be a room in the building, such as a kitchen or a bedroom. The design template may be, for example, a virtual rendering of a floor plan, blueprint, or skeleton of a building. The virtual building element may be configured adjust one or more intrinsic properties of the virtual building element in order to comply with the design requirements. These intrinsic properties may include, for example, dimensions, positioning information (i.e. an orientation of the virtual building element or a default location in a floor plan), and/or sub-elements (i.e. electrical outlets, doors, plumbing fixtures, and the like) located within the first virtual building element.

Each virtual building element may adjust one or more intrinsic properties based on a user's subsequent selection of additional building elements to the design template. For example, the addition of a second virtual building clement to the floor plan may necessitate moving the location of a door, an electrical outlet, or a fixture within the first virtual building element to comport with the design requirements. The virtual building elements may automatically adjust the location of an electrical outlet or a doorway, for example, to comport with the addition of an adjacent room to the building design. The design template or system as a whole may also adjust one or more extrinsic properties that implicate multiple building elements, such as a shear wall potential, a plumbing system spanning multiple rooms, and so on.

The systems and methods described herein can address the inherent complexities and challenges associated with the design and development process in the construction industry, particularly in the context of modular and prefabricated construction. The traditional linear or sequential development process, characterized by multiple stages each requiring specialized human expertise, can present significant constraints in terms of efficiency, adaptability, and cost-effectiveness. This can be particularly pronounced in the context of modular construction, where design variations and changes in regulations add an additional layer of complexity.

The systems and methods described herein can circumvent these challenges by introducing automation to the development process. The systems and methods described herein can move away from the conventional idea of replacing human experts with software agents, towards a more dynamic and flexible system that can better accommodate the intricacies and specificities of the modular construction process.

The systems and methods described herein can streamline the development process in modular construction, making it more efficient and adaptable to changes in design requirements and regulations. By improving the flexibility and adaptability of the design process, the systems and methods described herein can enhance the overall quality and performance of the end product, while also reducing costs and timeframes. In doing so, the systems and methods described herein can contribute to the advancement of the construction industry, particularly in the realm of modular and prefabricated construction. As used herein, modular and prefabricated construction may refer to a construction method that involves creating sections of a building (modules) off-site, then delivering them to the site location for assembly.

The systems and methods described herein can address several problems. First, the process of designing buildings, especially modular or prefabricated structures, can involve a multitude of considerations, including architectural aesthetics, structural integrity, and the effective implementation of mechanical, electrical, and plumbing (MEP) systems. Each stage can require specific expertise and involve detailed planning and coordination, making the design process complex and time-consuming.

Additionally, the traditional linear development process can be inherently inflexible. It can require a rigid sequence of steps, each dependent on the completion of the previous one. This can make it difficult to accommodate design variations or changes in regulations, which are common in the modular construction industry.

Additionally, the straightforward path of automatization, which involves replacing human expertise with software agents, is not without its challenges. As used herein, automatization (i.e. automation) may involve the process of making a manual procedure or process operate automatically, often through the use of software or machinery. This term can refer to the automation of the building design process. A software agent may refer to a software application that replicates the functions of a human expert in the design process in some embodiments. In particular, replacing human experts with software agents to automate a design process can require a significant investment in transforming the human know-how of experts at each stage into an equivalent software agent. Moreover, coordinating these software agents to streamline the automated development process can be complex.

Additionally, the current object-oriented programming approach, which is used in many design software systems, has limitations. While it can allow for the representation of building elements as objects with intrinsic attributes and behaviors, it may not adequately consider the interactions between these elements, which can impact the design of a coherent and functional building structure. As used herein, interactions may refer to the ways in which building elements (spaces) relate and respond to each other within the design. This can include spatial, functional, and regulatory relationships.

Additionally, in a typical development process, the integration of multiple disciplines (architecture, structural engineering, MEP systems design, etc.) can be challenging. Each discipline can its own specific considerations and requirements, and coordinating these in a cohesive and efficient manner can be a complex task.

Further, current methods of designing and planning buildings may lack the adaptability of the building elements. In other words, the building blocks or elements in the design phase can typically be static and lack the capability to adjust and adapt to their specific environment conditions or the constraints posed by other elements in the design.

Also, ensuring that designs are compliant with applicable building codes and acquiring necessary permits from local authorities can be a complex and time-consuming process. In some embodiments, designs may be “compliant” if they involve adherence to rules, regulations, and standards. Compliance can refer to meeting architectural, structural, MEP, and city or municipality codes and standards. Moreover, these regulations can change based on the location of the construction, adding another layer of complexity to ensuring design compliance. For example, design requirements may change between different cities or municipalities. In some embodiments, a city or municipality may be the local governing body that enforces building codes and issues permits for construction projects.

Further, due to the complexity and multiplicity of stages involved in the design process, it often requires a significant investment of time and money. This can make the construction process costly and long-drawn, especially when changes or iterations are required.

Also, in the world of modular or prefabricated construction, design variations can be common. However, current methods can struggle to efficiently handle these variations, leading to delays and increased costs. In some embodiments, design variations may be changes or alterations made to the initial design during the construction process. These variations can be due to changing client requirements, regulatory updates, or onsite construction conditions.

Finally, traditional design processes may tend to be sequential and don't adequately support the concurrent resolution of multi-disciplinary issues. This can lead to inefficiencies and extended timelines for project completion.

The systems and methods described herein can improve over existing technologies and approaches in the field of building design and construction, particularly in the context of modular or prefabricated structures. The areas of improvement can include, but are not limited to, the following.

The systems and methods described herein can involve the concept of sentient building blocks (i.e. virtual building elements), which are not just simple records of attributes. In some embodiments, attributes (i.e. properties) may refer to the specific characteristics or properties of a building block (space). These attributes could include physical dimensions, the presence of specific elements like windows or doors, and design guidelines. The sentient building blocks (i.e. virtual building elements) may include functional elements with the capability to adjust and adapt to specific environmental conditions and constraints posed by other elements in the design. This can represent a significant shift in the design paradigm and an enhancement over traditional static building elements.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the methods, devices, and systems described herein are not described with reference to any particular programming language. It will be appreciated that a variety of programming languages may be used to implement the teachings of the present disclosure as described herein.

### Exemplary System

### I. User Interface

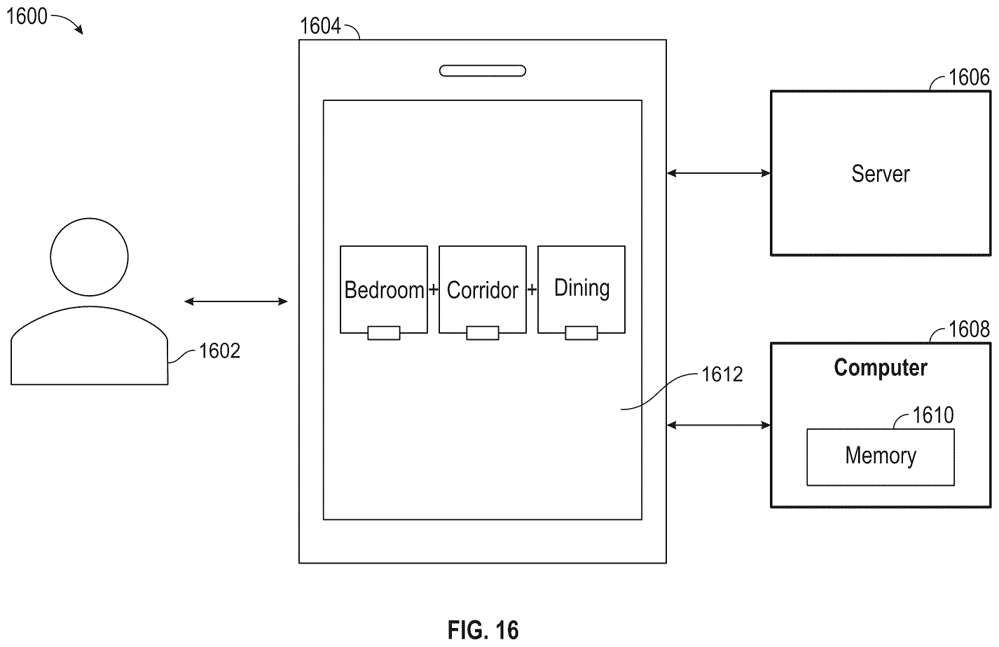

In some embodiments, a system for automating the design of buildings is provided. An exemplary system 1600 is shown in FIG. 16. As shown, the system may include a device having a display 1604 that can display a user interface 1612. In some embodiments, the device 1604 may be a mobile device, such as a smartphone, or device 1604 may be any other computing device having a display. In some embodiments, user interface 1612 may be part of a mobile application. The display may include a touch screen. The user interface 1612 may display a design template and may provide one or more features that can allow a user 1602 to design a building. In some embodiments, a user may be able to design a residential building, such as a house, condo, or apartment building using the design system 1600. In some embodiments, a user may be able to design a commercial building using the design system 1600. In some embodiments, design system 1600 may allow for the design of modular or prefabricated buildings for residential or commercial purposes.

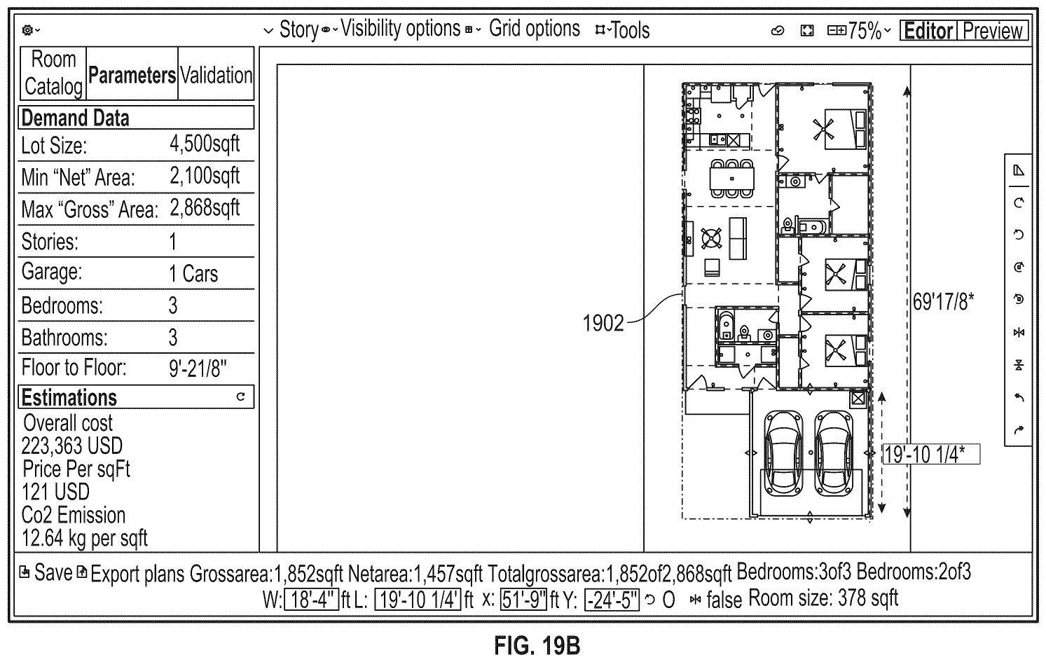

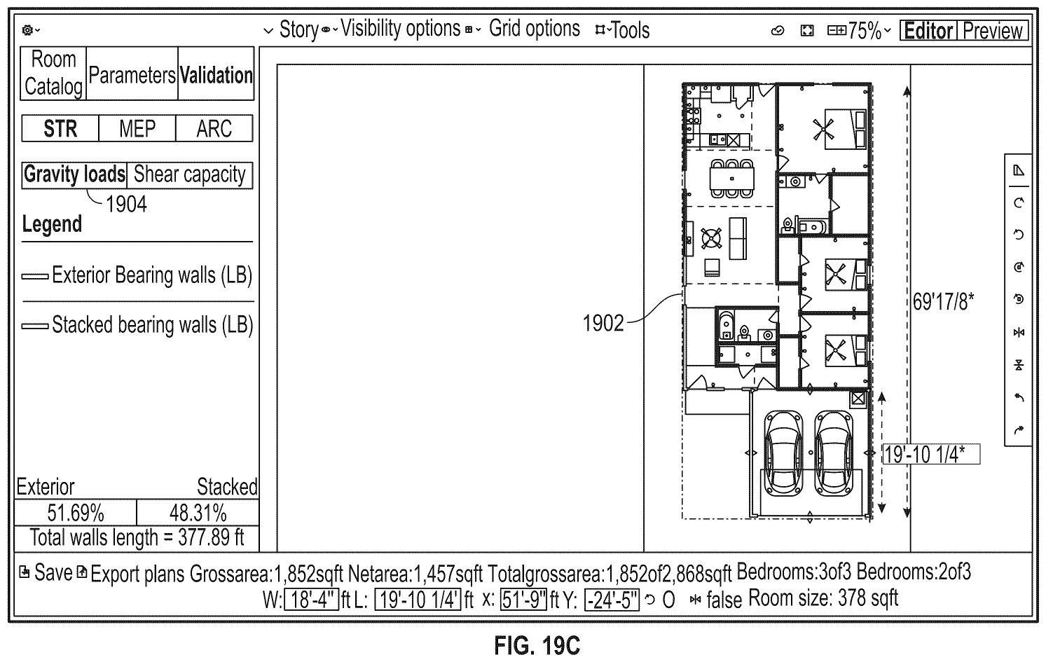

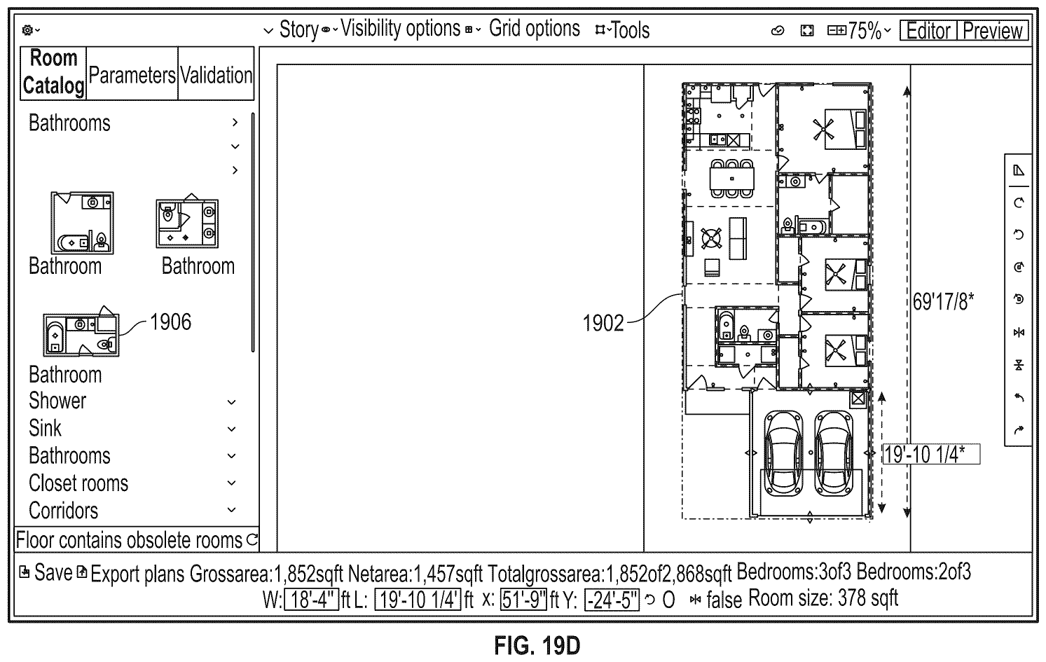

FIGS. 19A-19D depict exemplary appearances of user interfaces such as 1612 in accordance with some embodiments herein. For example, FIG. 19A shows various menu options that a user may choose from in a user interface, such as viewing overview specifications of the project, viewing design templates/floor plans, or viewing different renderings of a virtual building element. Similar menu options are also shown in FIG. 19B, allowing a user to view a catalogue of rooms and view various parameters or properties of the virtual building elements and/or the design template 1902. For example, an overall cost of the project, net and gross square footage, CO2 emissions that may result from the project, and other parameters or properties may be displayed as an output in the user interface for viewing by the user. As shown in FIG. 19C, the user interface may allow a user to adjust various properties and parameters of the virtual building element and/or the overall design template, such as gravity loads 1904. A user may also view outputs of adjustments to the various properties as they are performed in real time by the virtual building elements and/or the design template to automatically to comply with structural, MEP, or architectural requirements.

In some embodiments, the design template that is displayed on the user interface 1612 may be a virtual rendering of a floor plan, a blueprint, and/or a skeleton of the building, as shown by design template 1902 in FIGS. 19B-19D. In some embodiments, the design template 1902 may be a 2D or a 3D-rendering of the type of building that can be designed by the user. In some embodiments, the design template 1902 may depict a neighborhood or any other configuration of several building elements at once. In some embodiments, the design template 1902 may be a blank floor plan or skeleton, or it may be pre-configured with a default arrangement of virtual building elements (rooms, etc.) such that a user can either start from scratch or edit a default design. In some embodiments, the user interface may allow a user to select a virtual design template from a plurality of default design template options to start their design, and the user may customize the design template by adding or removing virtual building elements through the user interface.

The user interface 1612 may allow a user to select from one or more virtual representations of building elements that represent different rooms, features, etc. to be added to the design template, such as virtual building elements 1906 (various options for bathrooms) shown in FIG. 19D. For example, the virtual building elements may include different types of rooms to be added to the design. The different types of rooms may include a bedroom, a kitchen, a living room, a dining room, a bathroom, a basement, a corridor, a garage, or other examples. The virtual building elements may also include sub-elements of a room, such as windows, walls, doors, mechanical, electrical, and/or plumbing (MEP) fixtures or connections, or other examples. In some embodiments, the virtual building elements, i.e., 1906 or sub-elements therein, may represent modular or prefabricated building elements, such as prefabricated walls with various built-in utility conduits.

In some embodiments, a user may be able to tap or click on a virtual building element in the user interface 1612 to add it to the design template. In some embodiments, a user may be able to drag and drop a virtual building element into the design template in the user interface 1612. In some embodiments, the user may be able to select multiple virtual building elements at once. The user interface 1612 may include other ways for a user to select virtual building elements to improve the accessibility and ease-of-use of the user interface, such as through speech/voice recognition.

As used herein, a virtual building element that can be selected by a user of the user interface may be referred to as an “intelligent” or “sentient” building block. In this sense, a building block (i.e. virtual building element) may no longer be a static set of records defining certain attributes. Instead, each building block (i.e. virtual building element) can become a functional element capable of adjusting and adapting its own behavior to the specific environmental conditions of the design case. Moreover, the building blocks (i.e. virtual building elements) can be capable of interacting with each other, accounting for restrictions or relationships (such as interfaces or geometrical constraints) in their adaptation. This approach can eliminate the need for a linear development process as the intelligent building blocks (i.e. virtual building elements) concurrently resolve multidisciplinary issues.

In this context, the building blocks (i.e. virtual building elements) can also be classes of spaces within the house, building, or neighborhood, such as bedrooms, kitchens, living rooms, corridors, garages, etc. Each type of space may have its own unique characteristics that extend beyond simple dimensions. These characteristics can encompass architectural design considerations, structural engineering guidelines, and MEP (Mechanical, Electrical, Plumbing) system design guidelines. As the intelligent building blocks (i.e. virtual building elements) are aware of each other (e.g., a kitchen situated near a living room), some of these functions and attributes can be specifically dedicated to managing the interrelationships between building blocks, as will be described in further detail.

In some embodiments, the virtual building elements may be depicted in the user interface 1612 as two or three-dimensional renderings of the building element to be added to the building. The renderings may depict the virtual building element with varying levels of detail. For example, the virtual building element may be displayed as a blank floor plan, or the virtual building element may be displayed as a fully furnished room or a realistic-looking feature of a room, as shown described with respect to FIGS. 19A-19D. In some embodiments, a user may be able to select from virtual building elements of a uniform style or theme. In some embodiments, a user may be able to select from multiple virtual building elements that have the same type or class (i.e. a choice between several different kitchens, windows or doors) each having different styles, materials, or features, as shown in FIG. 19D. In some embodiments, the virtual building elements may be displayed as simple 2D/3D blocks or boxes, as shown in FIG. 16. The various appearances and default configurations of the virtual building elements or the design templates can be customized by a developer or programmer to meet the needs of a particular use case.

In some embodiments, the user interface 1612 may receive or be programmed with on one or more design requirements that the building design must satisfy. For example, the virtual building elements and/or the design template/system displayed on user interface 1612 may be programmed with one or more embedded design requirements using programming logic, as will be further described.

In some embodiments, the device 1604 may be in communication with a server 1606, which may store and transmit the design requirements to the device 1604. In some embodiments, the device 1604 may be in communication with an additional electronic device, such as computer 1608. In some embodiments, computer 1608 may store one or more design requirements in memory 1610 and may transmit the design requirements to the device 1604. In some embodiments, design requirements may be transmitted from device 1604 to server 1606 or computer 1608. In some embodiments, design system 1600 may not include an additional electronic device such as computer 1608, and the system may be configured to communicate with an external electronic device via a wireless or wired connection. In some embodiments, design system 1600 may not include server 1606 and may similarly be configured to communicate with an external server for sending or receiving data.

Examples of design requirements can include architectural requirements, mechanical, electrical, and plumbing (MEP) requirements, building codes, or zoning requirements. Architectural requirements may include structural requirements (such as load bearing requirements), aesthetic requirements (such as a preference by the user or neighborhood as to how the building should look), and/or requirements of building materials. Examples of mechanical, electrical, and plumbing (MEP) requirements can include heating, ventilation, and air conditioning (HVAC) requirements, requirements for routing and connecting electrical wires, conduits, pipes, and so on. Examples of building codes can include, for example, occupancy requirements, fire codes, and so on. Examples of zoning requirements can include, for example, zoning requirements for an apartment building, a mixed-use building, a single-family home, and other uses.

As described here and in further detail below, the virtual design template/system and/or the virtual building elements in the user interface may reject noncompliant building designs, prevent a user from designing a noncompliant building design, and/or automatically arrange the virtual building elements into a compliant design. In some embodiments, the design requirements may include logistical considerations, for example, if a modular building is being designed. These logistical considerations may include a weight limit to lift a modular building element using a crane, a number of hooks required to lift the modular building element using a crane, and/or requirements of various connectors that can be used to attach modular building elements to one another.

### II. Programming of Virtual Building Elements

In some embodiments, the virtual design template and/or the virtual design elements, or “sentient building blocks,” may be programmed using an object-oriented programming approach. An object-oriented programming approach involves configuring virtual objects with data stored in one or more fields associated with the object. The fields may define attributes or properties of the object. The objects may also contain code defining the operations, procedures, and methods that are to be performed on the data stored in each field. Examples of programming languages that may be used in an object-oriented programming approach include Java, Javascript, Python, C++, C #, Node.js, React, and other programming languages.

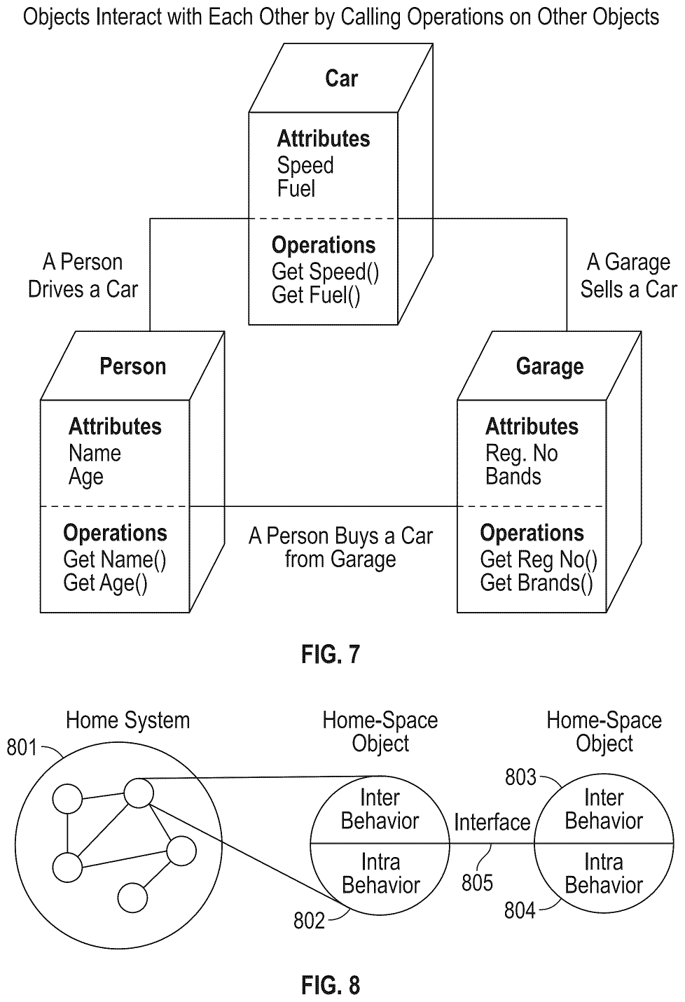

FIG. 6 illustrates an example of object-oriented programming in a generic system design process. As used herein, a design process may be a sequence of steps that an architect, engineer, or other professional follows to conceptualize, detail, and finalize a product design. Here, objects can have mainly intrinsic operational functions, handling their own behavior and state. FIG. 7 illustrates another example using object-oriented programming involving a person, a car, and a garage. The functions included here mainly can address lookups of attributes (i.e. getName( ) and getAge( ) and are based on intrinsic properties (name and age).

However, as shown in FIG. 8, an example of a system and method described herein can incorporate intelligent “building blocks” (i.e. virtual building elements) that possess both intrinsic and extrinsic functionalities. These building blocks (i.e. virtual building elements) can be elements of the construction design, such as rooms or spaces of a home. Each building block (i.e. virtual building element) can be constructed with a baseline format (i.e. the initial design format of a building block before any transformations (intrinsic or extrinsic) are applied). The baseline format may includes dimensions, relational restrictions for positioning elements, and various transformation operations. This programming approach can enable these building blocks (i.e. virtual building elements) to adapt and adjust their design attributes and relationships with other building blocks based on various factors, including design variations and changes in regulations, through the use of object-oriented programming.

FIG. 8. showcases the usage of object-oriented programming in the case of home design system 801. Here, sentient building blocks (i.e. virtual building elements) 802 can handle both inter-behaviors 803 (extrinsic, or between blocks), and intra-behaviors 804 (internal, intrinsic, or self adjustment/adaptation). The building blocks 802 may be paired together for the purposes of performing various inter-behaviors 803, as shown by interface 805 between the two blocks.

Table 1 below shows various examples of data fields and data types for the object-based programming of the virtual design elements or “sentient building blocks” described herein.

TABLE 1
Data Structure of a Building Block

| Field Name | Data Type | Description |
|---|---|---|
| Block_ID | Integer | Unique identifier for each |
| | | building block |
| Block_Type | String | Type of the block (e.g., |
| | | Bedroom, Kitchen, etc.) |
| Dimensions | Object | Dimensions of the block |
| | | (length, width, height) |
| Element_List | Array | List of sub-elements in the |
| | | block (window, door, outlet, |
| | | etc.) |
| Relational_Restrictions | Object | Rules for positioning of sub- |
| | | elements within the block |
| Intrinsic_Operations | Array | Self-related actions like |
| | | resize, rotate, etc. |
| Extrinsic_Relations | Array | Relations to other blocks |

In some examples, the building blocks (i.e. virtual building elements) can possess a baseline format that includes dimensions (2D and 3D related), other elements included in the space (e.g., window, electrical outlets, door, closet), and relational restrictions when positioning these elements (e.g., limitations or guidelines that govern the placement or interaction of elements within a building block or between different building blocks). These building blocks (i.e. virtual building elements) can also include intrinsic transformation operations such as resize, rotate, and so on. Additional transformation guidelines may also be included, such as anchor points for resizing or the effects of rotation on room elements.

For example, the virtual building elements, or building blocks, may contain data stored in one or more fields, such as an ID or unique identifier for each block. The building blocks may also contain a type (or class) field indicating the type of room the block is to represent. The building blocks may also have a dimensions field, including dimensions such as length, width, or height, in 2D or 3D. There may also be a field listing sub-elements that are located within the block (i.e. windows, doors, etc. within a room). A virtual building element may contain additional fields representing functional specifications such as color, material, waterproofing attributes, soundproofing attributes, and other examples. Examples of data types to be stored in the various fields of the building blocks can include integers, strings, objects, or arrays.

There may be a field listing various rules for positioning sub-elements within the block, which may be called relational restrictions. One such rule may be a minimum distance from an electrical outlet to a door, for example. Other fields can include intrinsic operations which may include self-related actions such as resizing or rotating, or extrinsic operations affecting relations between two different blocks, such as a distance from one block to another or rules for positioning one block with respect to another in the building design.

For example, prior to a user initiating the design process, a backend programmer or software developer may program the virtual design template (i.e. the floor plan itself) and/or the virtual building elements (i.e. a particular room) with programming logic comprising various rules, constraints, and/or restrictions on possible building designs. In some embodiments, the programmed logic can be based on various design requirements, such as local building codes, architectural requirements, and so on, that the ultimate building design must satisfy in order to comply with applicable regulations. The design requirements may be publicly available building codes or regulations, or they may be requirements unique to a particular design case, such as aesthetic preferences of a client.

For example, the virtual design template and/or the virtual building elements may be programmed with logic governing minimum and maximum distances between doorways and electrical outlets, logic reflecting fire codes such as minimum numbers of sprinkler systems in a building or smoke detectors in a room, logic reflecting minimum load bearing capabilities of particular walls, and so on. By embedding the virtual building elements and/or the virtual design template with logic reflecting the various design requirements, the design system can assess a building design for compliance and update an output of the building design that is displayed to the user via the user interface in real time. In some embodiments, the programming logic may be specific to a particular design case and may include design requirements that are unique to a particular design job. In some embodiments, some of the programming logic may be more generally applicable to other design cases depending on whether the design requirement is one of general applicability (i.e. a general fire code) or is more specific to an individual design (i.e. an aesthetic preference of a particular client or a design requirement that is unique to a particular type of building).

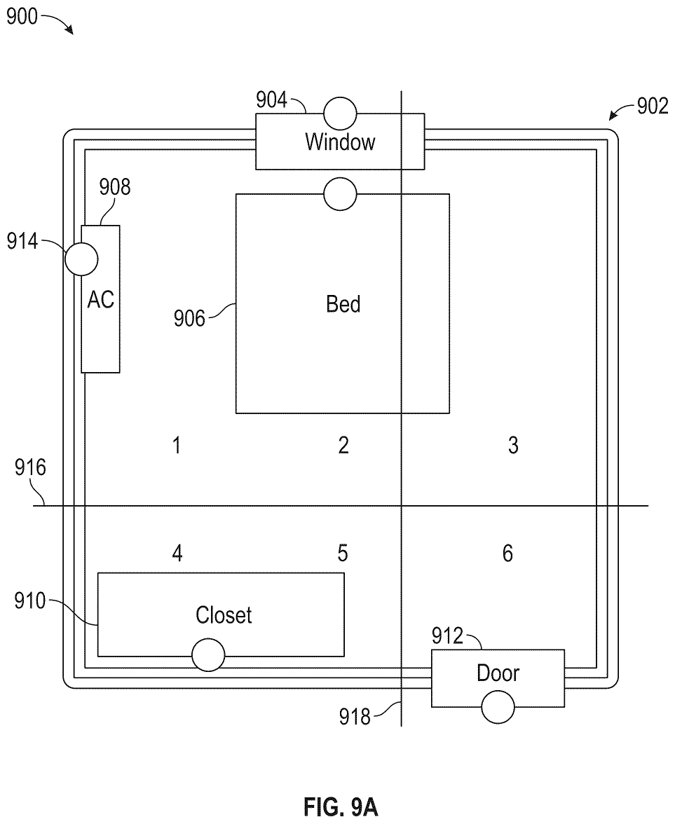

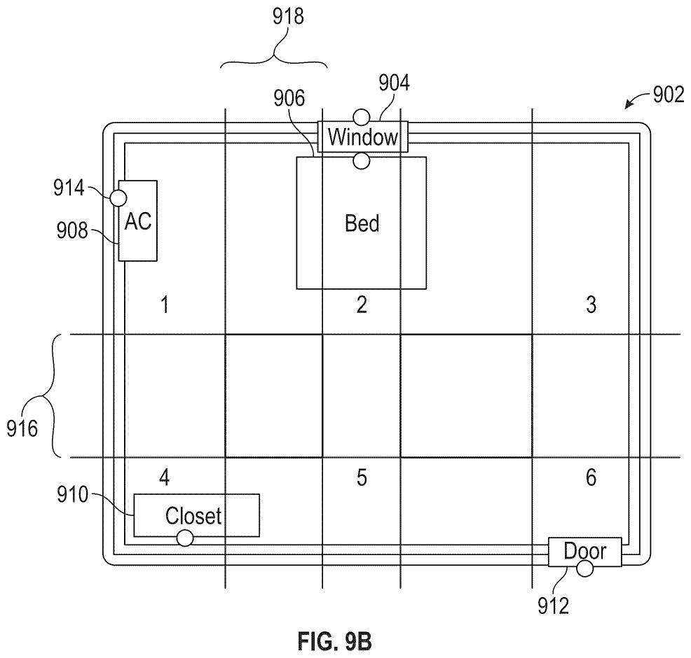

FIG. 9A demonstrates the 2D geometrical intra-behavior of a building block (i.e. virtual building element) 900, i.e. the adjustment of one or more “intrinsic” properties, using a base design as a starting point. As used herein, “intrinsic” properties may refer to properties of an individual building block or virtual building element that are capable of being adjusted by the building block through self-related actions. Intrinsic properties may be adjusted without regard to a relationship with another building block. In other words, intrinsic properties can be properties of a room that could still exist even if no other rooms were present in a building. For example, as shown in FIG. 9A, the bedroom may include various sub-elements, such as a wall 902, a window 904, bed 906, A/C unit 908, closet 910, and door 912. The sub-elements and their respective positions within the bedroom may be intrinsic properties since they are internal to the individual bedroom block in the overall building design.

FIG. 9B shows an example of adjusting an intrinsic property, in which building block (i.e. virtual building element) 900 from FIG. 9A can resize itself while preserving certain aspects of the base design, such as the location of certain elements. In this example, block 900 is stretched in two directions that are perpendicular to two axes 916 and 918. However, as indicated by a visual comparison of the rectangles numbered 1-6 in FIG. 9A and FIG. 9B, block 900 has been resized in a manner that preserves the relative locations of sub-elements, e.g. window 904 and bed 906, within the block 900. Additionally, or alternatively, or more sub-elements can be resized or scaled independently from the building block as a whole. For example, the sub-elements may be configured with one or more anchor points 914 which provide a point at which the sub-elements may be scaled, rotated, or anchored, either automatically by the system or manually by a user of the user interface.

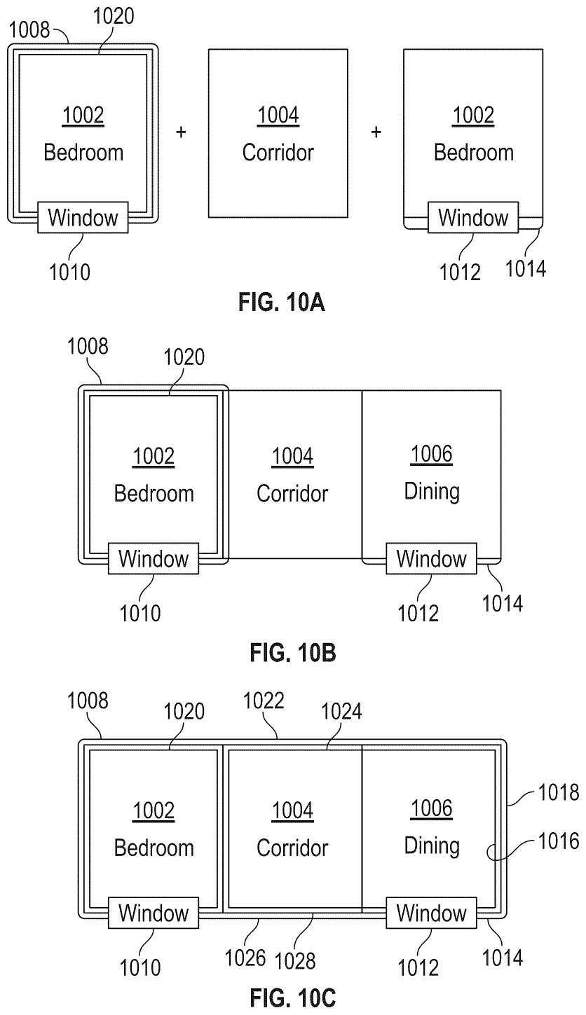

Referring to FIG. 10A, this figure demonstrates the intra-building block (i.e. virtual building element) behavior (i.e. intrinsic properties) when blocks need to “connect” (e.g., adjacent rooms in an isolated state, prior to pairing or connecting). The intrinsic properties of the building blocks reflect architectural wall existence and ensure that wall openings are considered. For example, bedroom 1002 has exterior walls, e.g. 1008, interior walls, e.g. 1020, and a window 1010. These intrinsic properties may be configured in a default configuration within bedroom 1002 prior to connecting or pairing with blocks 1004 and 1006. The block (i.e. virtual building element) corresponding to corridor 1004 may not have interior or exterior walls in its default state. The block corresponding to dining room 1006 may have a window 1012 on an exterior wall 1014 in a default configuration. As shown in FIG. 10B, building blocks (i.e. virtual building elements) from FIG. 10A can initially be “connected”, with preservation of the intrinsic properties. For example, windows 1010 and 1012, as well as walls 1008, 1020, and 1014, are all located in the same spot in FIG. 10B as in FIG. 10A.

The design template may also include one or more extrinsic properties. As used herein, “extrinsic properties” may refer to properties of the design template that are defined or affected by a relationship between multiple building blocks (virtual building elements), such as load-bearing capabilities of one wall affected by other walls, continuity of electrical wires/pipes between rooms, and so on. Depending on whether a property can exist in a building block in its default or individual state, an “intrinsic” property of a building block may become an “extrinsic” property of the overall design template when the block is paired with another block in the design template, if the property is somehow shared between blocks, is affected by a rule governing the relation between both blocks, or implicates multiple blocks.

For example, in FIG. 10C, exterior walls 1022, 1026 and interior walls 1024 and 1028 have been added to the corridor 1004. This can result from the system identifying that corridor 1004 is located in between two building blocks (i.e. virtual building elements), bedroom 1002 and dining room 1006, that each have exterior walls 1008 and 1018. Thus, the system may be configured to recognize that corridor 1004 is adjacent to two rooms along the exterior perimeter of the building and should thus have exterior walls that are continuous with the adjacent rooms. The exterior walls of the corridor could thus be considered “extrinsic properties” since they are adjusted (e.g. added to the design) based on the relationship between the corridor and the other rooms. In this sense, an “extrinsic” property of the design template may also be an “intrinsic” property of a building block (i.e. virtual building element) since the external wall is also a property of the individual corridor building block itself. Extrinsic properties of the design template can include a shear wall potential, an MEP system, an overall layout of virtual building elements in the design template, or combinations thereof.

Table 2 below shows an exemplary data structure indicating a relation between two building blocks, which may be paired for the purposes of performing one or more operations on the blocks in executing the design requirements of the building design.

TABLE 2
Data Structure of Related (Paired) Building Blocks

| Field Name | Data Type | Description |
|---|---|---|
| Relation_ID | Integer | Unique identifier for each |
| | | relation |
| Block_ID_1 | Integer | ID of the first block of the |
| | | relation |
| Block_ID_2 | Integer | ID of the second block of the |
| | | relation |
| Relation_Type | String | Type of relation (e.g. |
| | | adjacent, above, below) |
| Relation_Rules | Object | Specific rules governing the |
| | | relationship |

As shown, to indicate a relationship between two or more building blocks (i.e. virtual building elements), the data fields may include a Relation ID, an ID of one or more individual blocks in the relationship, a type of relationship (such as adjacent, above, below, etc.), and relational rules governing the relationship between the blocks. For example, the relation rules may reflect one or more of the design requirements that the building design must follow in order to comply with local building codes that are programmed into the building block as logic. Therefore, the building blocks can interact with each other, adapting their design attributes and relationships accordingly.

The configuration of building blocks into a compliant building design in accordance with the relational rules described above may involve changing intrinsic properties of the building blocks and/or extrinsic properties of the design template. Referring back to the example shown in FIGS. 10A-10C, the system may recognize that dining room 1006 is missing interior walls, e.g. 1016, opposite the exterior walls 1018. There may be a relational rule (i.e. a design requirement) stating that exterior walls in a dining room must have corresponding interior walls for insulation purposes. Additionally, the system may be programmed with a relational rule specifying that walls are to be maintained between the bedroom 1002 and any other adjacent room for privacy reasons. Alternatively, there may be a relational rule permitting the dining room 1006 to open up to another room, such that a wall is not automatically added between corridor 1004 and dining room 1006. The intrinsic properties of the dining room (i.e. the interior walls) can be adjusted to comport with the relational rule. The extrinsic properties of the design template (i.e. the lack of a wall between the corridor 1004 and dining room 1006 and its impact on the load bearing of other walls in the building structure) may also be adjusted by the system in accordance with the relational rules (i.e. design requirements).

The virtual design template and/or the virtual building elements (i.e. the building blocks) may be configured to perform various operations on the intrinsic or extrinsic properties described above. Table 3 below shows an exemplary data structure for one or more operations that are to be performed on a building block.

TABLE 3
Data Structure of Operations Performed on Building Blocks

| Field Name | Data Type | Description |
|---|---|---|
| Operation_ID | Integer | Unique identifier for each |
| | | operation |
| Block_ID | Integer | ID of the block performing |
| | | the operation |
| Operation_Type | String | Type of operation (e.g., |
| | | resize, rotate) |
| Parameters | Object | Parameters required for the |
| | | operation |

As shown, the building blocks (virtual building elements) may be configured with one or more operations that can be executed to adjust the intrinsic properties of the building blocks and/or the extrinsic properties of the overall design template. The operations may be performed automatically by the system to ensure compliance with the relational rules, or the operations may be performed manually by a user. The data fields for the operations may include, for example, an operation ID, a block ID, an operation type, and parameters required for the operation. Exemplary operations may include intrinsic operations, such as resizing or rotating a block without regard to a relation with other blocks, as well as extrinsic operations, such as automatically adding or removing shared walls, automatically orienting adjacent blocks to ensure continuity of pipe routing, or automatically reorienting windows to maximize shear wall potential. In other words, the operations may include the functions to be performed on the data to execute the relation rules described above. Exemplary parameters that may be required for the various operations to be performed on the blocks may include, for example, dimensions, locations of MEP connections, a difference in class (or type) between one block and an adjacent block, and/or any of the intrinsic or extrinsic properties described above.

An example of adjusting an extrinsic property of the design template (i.e. the execution of an extrinsic operation as described in Table 3) can include maximizing shear wall potential. A shear wall potential can be determined by a wall's ability to resist load parallel to its plane. Shear resistance can be determined by geometrical attributes of the wall and structural elements in it.

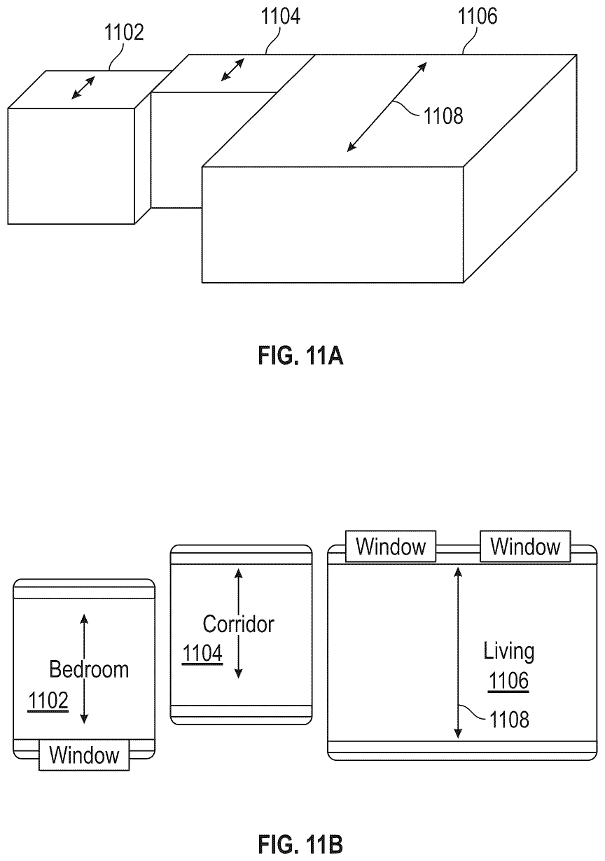

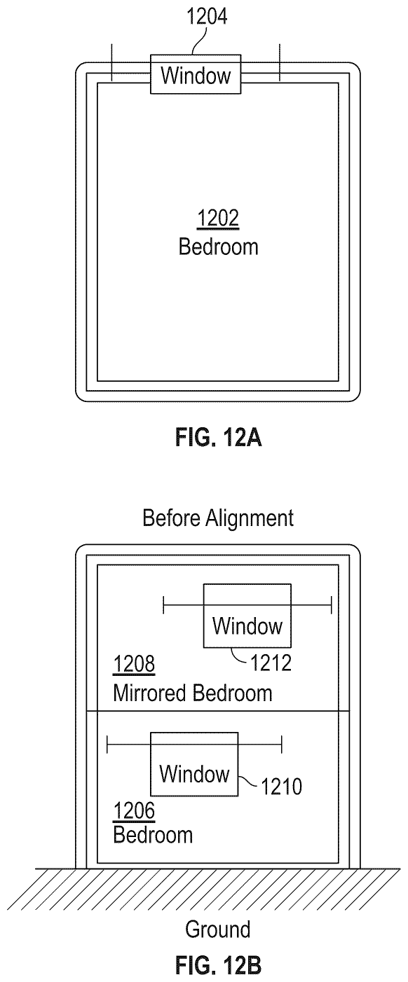

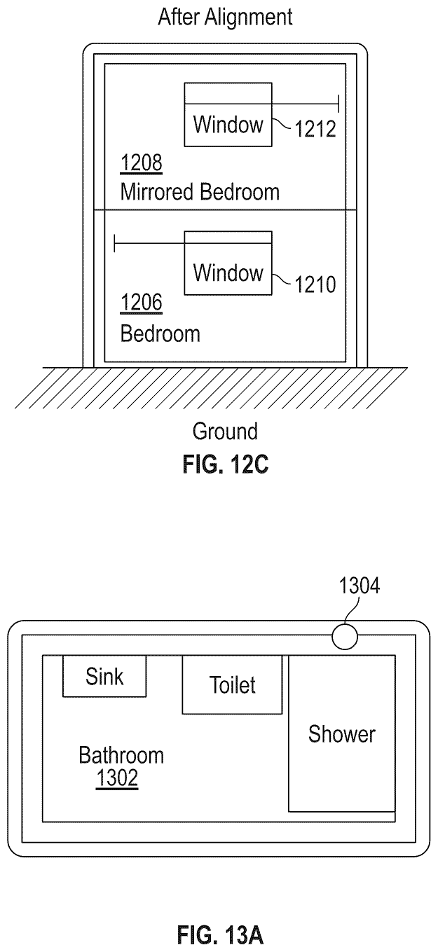

An exemplary shear wall potential operation is shown in FIGS. 11A-12C. FIG. 11A introduces 3D considerations of the structural design. The building blocks (virtual design elements) in this case (bedroom 1102, corridor 1104, and living room 1106) can perform analytical modeling, detect load definitions, determine a floor span and detect potential shear (load bearing) walls. FIG. 11B shows how the building block coverage area (floor span 1108) can be used for calculating loads, factoring in the physical dimensions and properties of the blocks.

FIG. 12A demonstrates a situation where the shear wall potential may not not maximized due to the current window position within the building block. As shown, window 1204 is located too close to a corner of bedroom 1202, which can prevent the wall from reaching its full load-bearing potential. FIG. 12B illustrates how the situation demonstrated in FIG. 12A can recur on other floors, showing the cumulative effect of design decisions. For example, the misalignment of window 1210 in bedroom 1206 is mirrored by the misplacement of window 1212 in bedroom 1208. Since the windows are not properly aligned, the shear wall potential of the exterior walls of both bedrooms can be reduced, which can compromise the structural integrity of the design. Due to the logic rules embedded within the virtual building elements and/or the design template that may require shear wall potential to be maximized, the system can prevent the user from placing the windows in this manner and/or can automatically realign the windows into a compliant configuration. FIG. 12C shows how building blocks 1206 and 1208 on different floors realign windows 1210 and 1212 such that the system can automatically preserve aesthetics and maximize shear wall potential.

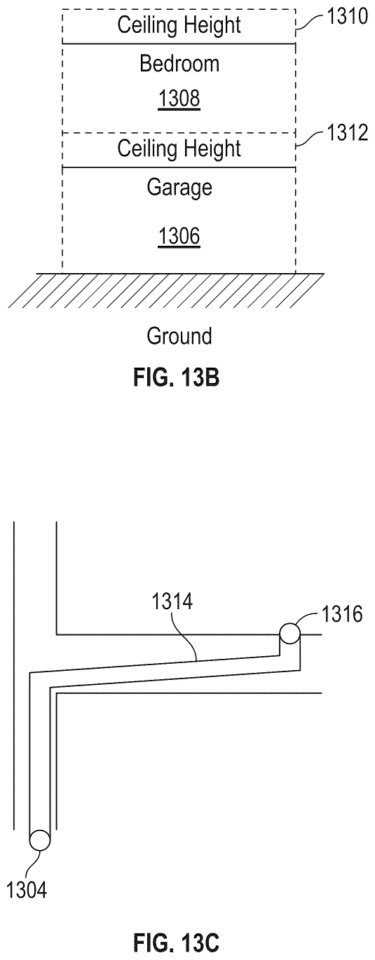

FIG. 13A presents an example of MEP considerations, specifically plumbing pipe routing. As described above, one of the extrinsic operations that can be performed on the building blocks (virtual building elements) can include aligning and connecting wires, pipes, and other MEP components across each building block. These operations may be performed so that the resulting building design complies with various MEP requirements, including the proximity of pipes to exterior walls, a required number of connection points to drainage, feasibility of pipe angles to support gravitational piping requirements, and so on. For example, bathroom 1302 in FIG. 13A can include a location of a main water line 1304. As shown in FIG. 13C, the virtual design template and/or the building blocks may be programmed to detect the location of different pipe openings, valves, etc, such as plumbing points 1304 and 1316. The logic rules reflecting MEP requirements that are embedded within the building block (i.e. the virtual design template) can allow for the automatic adjustment between possible plumbing routes 1314 between the two plumbing points 1304 and 1316. FIG. 13B also shows how the 3D arrangement of building blocks can be factored into the MEP considerations, and how MEP considerations can be factored into the 3D arrangement of building blocks. For example, ceiling heights 1310 and 1312 may be adjusted to provide room for pipes or electrical wiring to be embedded within a wall or ceiling panel of a garage 1306 and a bedroom 1308 or to comply with any minimum height requirements of sprinklers, smoke detectors, and so on.

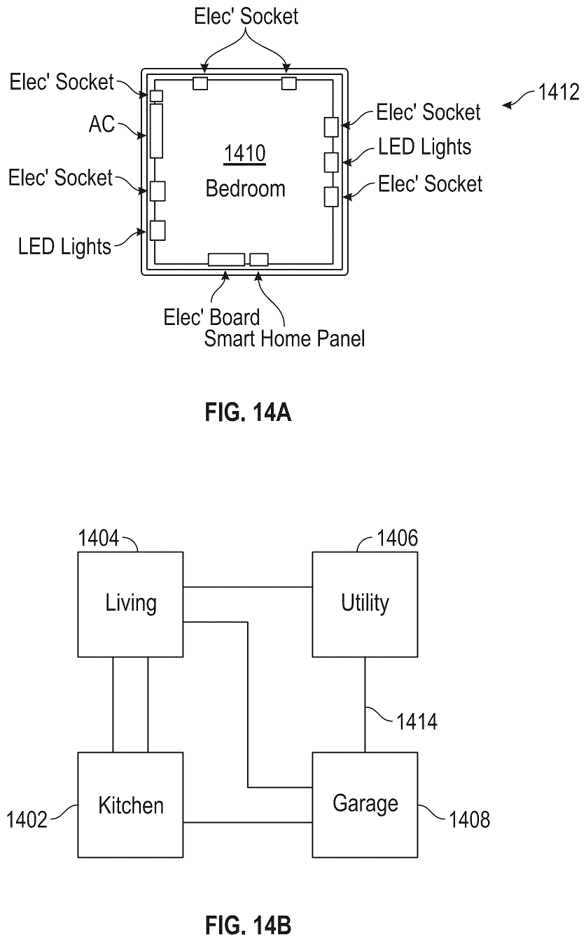

FIG. 14A presents another example of MEP considerations, specifical with electrical routing. FIG. 14A illustrates how electrical routing can be detected automatically by first listing electrical components within the building blocks (i.e. virtual building elements), highlighting the electrical considerations in the design process. Examples of electrical components in a bedroom 1410 can include, for example, electrical sockets, light fixtures, breaker panels, and data conduits. FIG. 14B shows how building blocks can be schema “aware” (meaning they understand planned connections between spaces), and routing 1414 follows accordingly. This can ensure a logical, efficient layout of electrical components. For example, the system may electrically connect the kitchen 1402 to the living room 1404 and garage 1408 since a direct connection to utility closet 1406 may not feasible or desirable based on the number and/or location of electrical panels or breakers within the building.

In the examples shown and described with respect to FIGS. 13A-14B, the system may be able to automatically configure and adjust the routing of pipes, electrical wiring, and so on, to comport with MEP requirements imposed by local building codes. As described above, MEP requirements imposed by local building codes may be stored as logic within the relation rules field. MEP requirements may include, for example, requirements to have a fire sprinkler system in a particular type of building or room, a number of smoke detectors and distances between them, positioning of electrical outlets to confirm compliance with code requirements (height, positioning and distance between outlets) and so on.

In some embodiments, individual MEP components are automatically adjusted (i.e. added, aligned, and connected in a compliant manner) upon the selection of the respective building blocks (i.e. virtual building elements) by the user. In some embodiments, routing of pipes, wires, and larger MEP systems may be adjusted over multiple building blocks (i.e. virtual building elements) to comply with the MEP requirements. In this manner, an individual MEP component (i.e. an electrical outlet in a room) may be an example of an “intrinsic” property, while multiple MEP components making up an MEP system (i.e. a network of pipes or wires spanning multiple rooms) can be considered an “extrinsic” property of the design template as a whole.

Table 4 below illustrates an exemplary data structure showing fields of data reflecting the relationships between various blocks in a design template.

TABLE 4
Data Structure of Building Block Relationships

| Relation ID | Block_ID 1 | Block_Type_1 | Block_ID_2 | Block_Type_2 | Relation_Type |
|---|---|---|---|---|---|
| 1 | 101 | Bedroom | 102 | Bathroom | Adjacent |
| 2 | 101 | Bedroom | 103 | Kitchen | Above |
| 3 | 102 | Bathroom | 101 | Bedroom | Adjacent |
| 4 | 103 | Kitchen | 101 | Bedroom | Below |
| 5 | 104 | Living Room | 105 | Garage | Adjacent |
| 6 | 105 | Garage | 106 | Bathroom | Above |

As shown, information regarding the relationships between each of the building blocks, or virtual building elements in a building design, may be indicated by data reflecting a unique relation ID, a unique block ID, a block type (i.e. class of room) and a relation type (i.e. adjacent, above, or below). Relationships between blocks may be used by the system to automatically configure the building design such that it complies with one or more design requirements or restrictions.

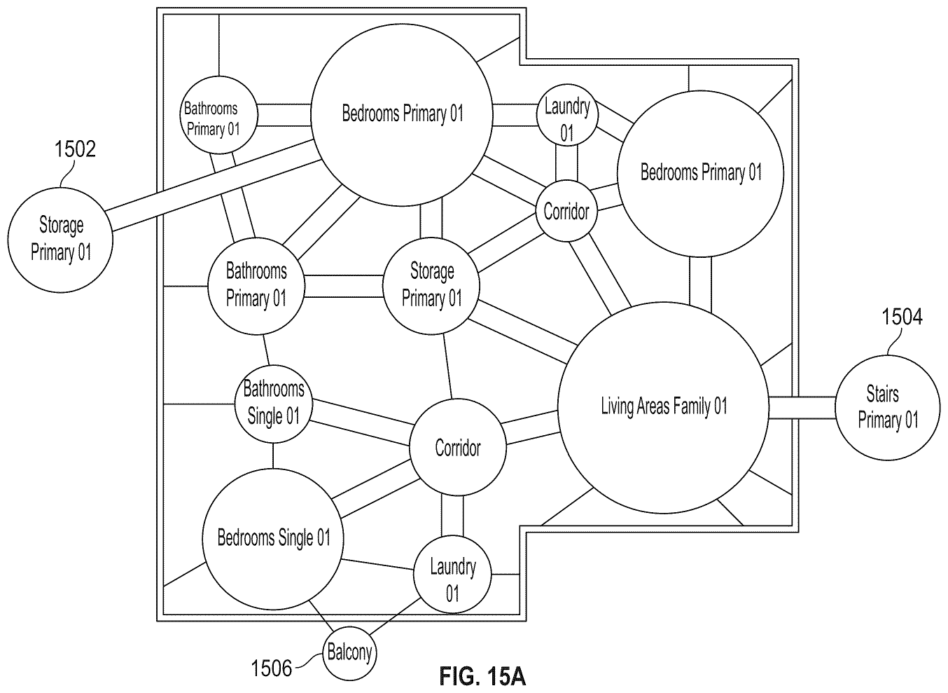

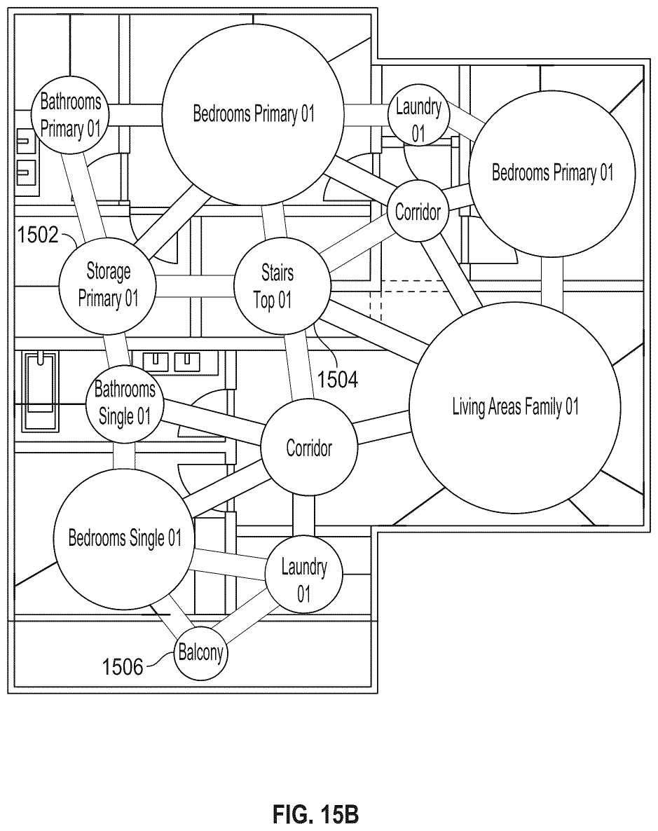

FIGS. 15A and 15B illustrate how extrinsic properties of the design template may be adjusted. As shown in FIGS. 15A and 15B, the virtual design template and/or the building blocks (i.e. virtual building elements) may perform a space adjacency analysis in which building blocks “sense” and “measure” inter-relationships. It demonstrates the building blocks' ability to understand their position relative to one another and adjust extrinsic properties related to relationships between building blocks accordingly.

For example, FIG. 15A shows various building elements in a design template. When initially selected by the user, storage 1502 is duplicative of another storage block and is located outside of the floor plan. Balcony 1506 and stairs 1504 are also located outside of the floor plan. FIG. 15B shows how the virtual design templates and/or the building blocks can identify possible missed spaces or extra spaces (voids) that are detected using the space adjacency analysis and adjust the extrinsic properties of the design template accordingly. For example, in FIG. 15B, storage 1502 has been moved into the design template, replacing a duplicative bathroom. Meanwhile, stairs 1504 have been moved into the design template, replacing the duplicative storage room. Balcony 1506 has been moved into the design template but has been properly placed outside an exterior wall of the design template in accordance with a design requirement. These figures showcase the system's ability to ensure efficient use of space by adjusting extrinsic properties of the design template and detect any potential issues in the design layout that could violate one or more design requirements.

Referring back to system 1600 shown in FIG. 16, to carry out the functions/operations programmed within the design template and/or the building block (i.e. virtual building element), a user 1602 may first initialize the block by selecting the block to be included in the building design template using the user interface 1612. Upon initialization by the user, the building block (i.e. virtual building element) may automatically adjust its intrinsic properties, such as its overall dimensions and the dimensions of any included sub-elements (i.e. windows, doors, closets, etc.) based on one or more design requirements. As described above, the one or more design requirements may be programmed in one or more data fields of the building block (i.e. virtual building element), such as relational restrictions or relation rules.

A building block (i.e. virtual building element) may be coded with one or more operations configured to adjust intrinsic properties of the building block or extrinsic properties of the design template to obtain and maintain a compliant building design. In some embodiments, the operations may be executed by the building block automatically upon initialization. In some embodiments, the operations may be configured to be performed on the building block after some triggering event (i.e. the initialization of another block that would cause the building design to be noncompliant). In some embodiments, the building block may be configured with certain operations that are configured to be performed automatically upon initialization as well as operations that are configured to be performed responsively to restore compliance with the design requirements. In some embodiments, the operations may prevent the selection or placement of a building block by a user if the selection or placement could cause the design to violate one or more design requirements.

For example, a building block (i.e. virtual building element) and/or a design template may be configured to automatically adjust its intrinsic properties, such as its dimensions, upon initialization using a first intrinsic operation. The building block and/or a design template may also be configured to responsively adjust extrinsic properties, such as automatically orienting windows to maximize shear wall potential with building blocks on a higher or lower floor of the building using one or more additional extrinsic operations.

In some embodiments, device 1604 may be configured to communicate with a computer 1608. In some embodiments, computer 1608 may be internal to, or part of, design system 1600. In some embodiments, computer 1608 may be external to design system 1600. In some embodiments, computer 1608 may include storage such as memory 1610 that can store data associated with design requirements, such as libraries of building codes, local regulations, and the like. Additionally, the finalized building designs produced by the system may be stored in storage such as memory 1610. In some embodiments, device 1604 may be configured to communicate with a server 1606 over a wireless network. In some embodiments, server 1606 may be part of design system 1600, or it may be external to design system 1600. In some embodiments, the server 1606 may be a cloud server. In some embodiments, data associated with a building design may be anonymized or encrypted to ensure secure transmission over a network or server.

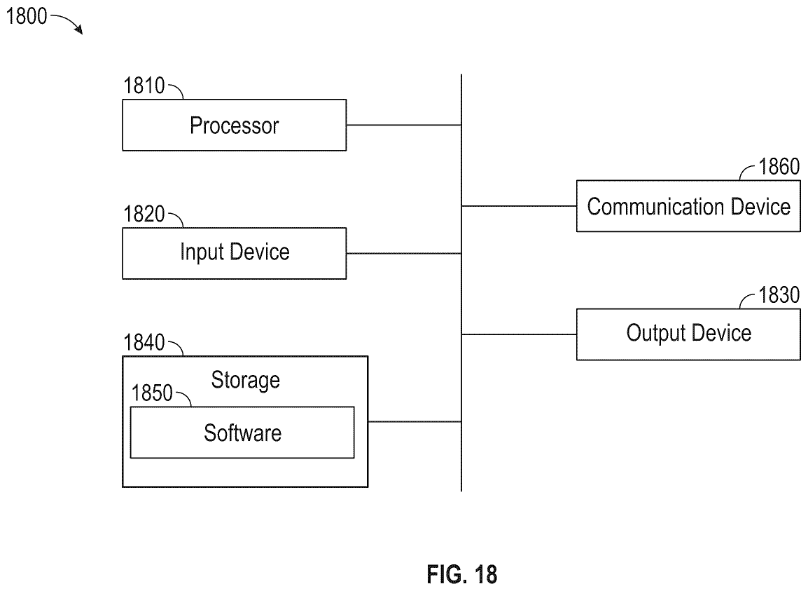

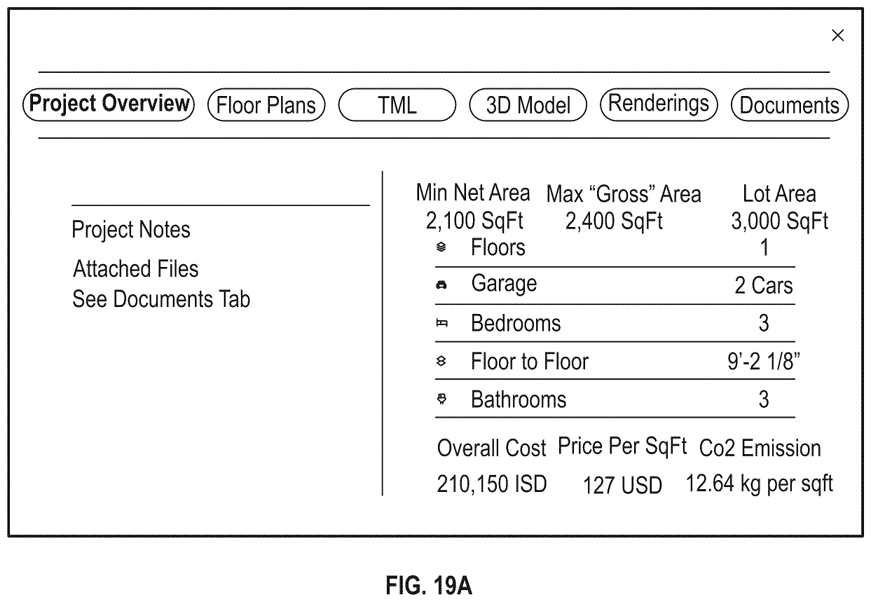

FIG. 18 depicts parts of a computer, in accordance with various embodiments. As will be appreciated, computer 1608, described with respect to FIG. 16, can include one or more of the components as will be described with respect to computer 1800. Computer 1800 can be a component of a system for designing a building using a user interface such as 1600, displaying a building design, or configuring a user interface to automatically generate compliant building designs based on a user input.

Computer 1800 can be a host computer connected to a network. Computer 1800 can be a client computer or a server. As shown in FIG. 18, computer 1800 can be any suitable type of microprocessor-based device, such as a personal computer, workstation, server, videogame console, or handheld computing device, such as a phone or tablet. The computer can include, for example, one or more of processor 1810, computer input device 1820, output device 1830, storage 1840, and communication device 1860. Computer input device 1820 can generally correspond to those described above and can either be connectable or integrated with the computer.

Computer input device 1820 can be any suitable device that provides input, such as a touch screen or monitor, keyboard, mouse, or voice-recognition device. Output device 1830 can be any suitable device that provides output, such as a touch screen, monitor, printer, disk drive, or speaker.

Storage 1840 can be any suitable device that provides storage, such as an electrical, magnetic, or optical memory, including a RAM, cache, hard drive, CD-ROM drive, tape drive, removable storage disk, or other non-transitory computer readable medium. Storage 1840 can include one storage device or more than one storage device. As used herein, the terms storage, memory, and/or storage medium/media may refer to singular and/or plural devices which may store data and/or code/instructions individually, redundantly, and/or in cooperation with one another, for example in a local and/or cloud storage environment. Communication device 1860 can include any suitable device capable of transmitting and receiving signals over a network, such as a network interface chip or card. The components of the computer can be connected in any suitable manner, such as via a physical bus or wirelessly. Storage 1840 can be a non-transitory computer-readable storage medium comprising one or more programs, which, when executed by one or more processors, such as processor 1810, cause the one or more processors to execute methods described herein.

Software 1850, which can be stored in storage 1840 and executed by processor 1810, can include, for example, the programming that embodies the functionality of the present disclosure (e.g., as embodied in the systems, computers, servers, and/or devices as described above). In some embodiments, software 1850 can be implemented and executed on a combination of servers such as application servers and database servers.

Software 1850, or part thereof, can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 1840, that can contain or store programming for use by or in connection with an instruction execution system, apparatus, or device.

Software 1850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 1800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1800 can implement any operating system suitable for operating the network. Software 1850 can be written in any suitable programming language, such as C, C++, Java, or Python. In various embodiments, application software embodying the functionality of the present disclosure can be deployed in different configurations, such as in a client/server arrangement or through a web browser as a Web-based application or Web service, for example.

### Exemplary Method

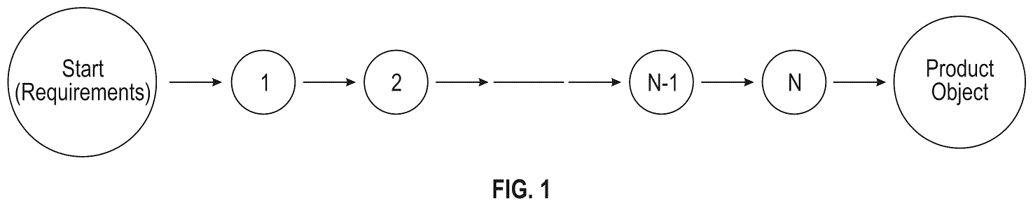

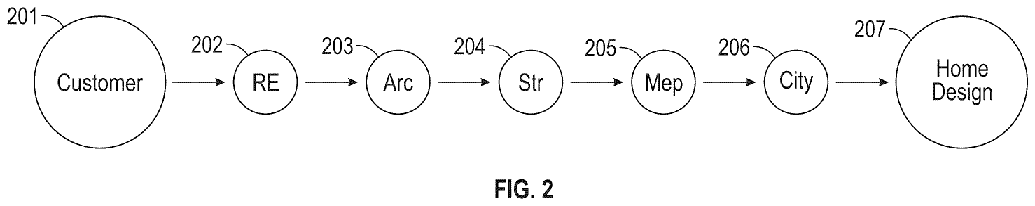

In some embodiments, a method for designing a building using a design system is provided. The design system may be system 1600 described in detail above. System 1600 may modify various construction processes in allowing a user to design a building in accordance with the methods described herein. For example, the system may begin with a design process, as shown in FIG. 1. The process may include several stages, each building upon the last, leading to a final product or output. The design process may then adapted to the building design process within the construction industry, as shown in FIG. 2. The design process may include typical stages like receiving a customer request and building preferences 201 and addressing real estate requirements such as land acquisition requirements 202. In some embodiments, real estate requirements may include those typically taken into account by a professional who coordinates and orchestrates the process of real estate development, such as validating initial designs, ensuring compliance, and estimating project costs. In some embodiments, the design process may involve addressing architectural requirements 203, addressing structural requirements 204 (which may be included under architectural requirements 203), addressing MEP (Mechanical, Electrical, and Plumbing) requirements 205, and addressing local building codes and zoning requirements 206. These stages can follow one another in a linear progression leading to the final home design 207.

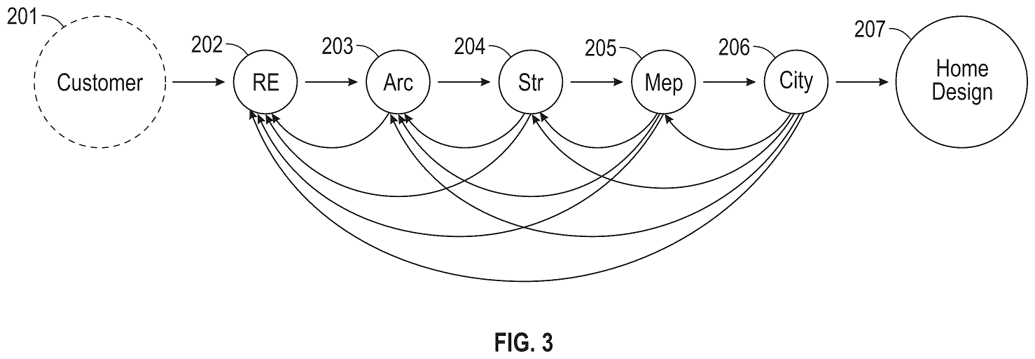

FIG. 3 modifies FIG. 2 by illustrating potential iterations of stages 201-207. If a current stage involves significant changes, previous stages may need to be repeated. It shows the cyclical nature of design iterations within the construction process. One of the benefits of the design systems and methods described herein is that the design process can be made more adaptable, such that different building elements can adjust and adapt to their specific environment conditions or the constraints posed by the requirements of other stages of the design. This can reduce the need for repeating an entire previous step of the design process if changes to the building design are necessitated by a subsequent step and can make the design process faster and more efficient.

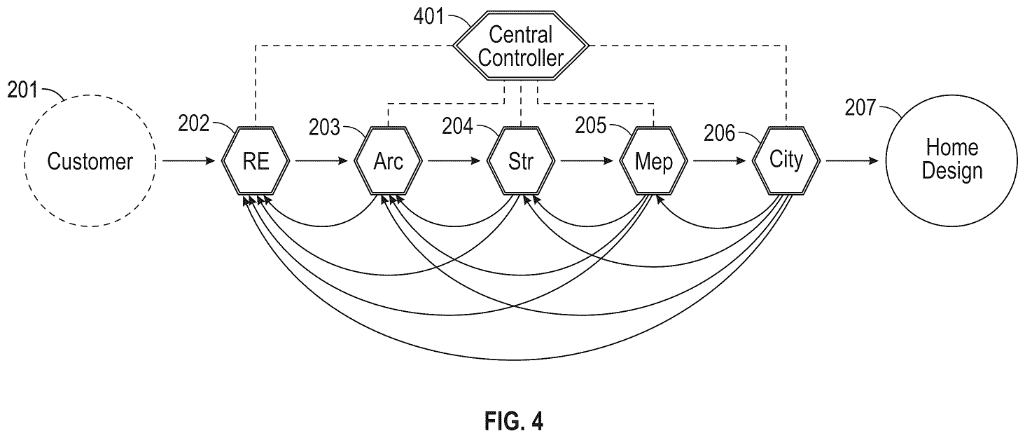

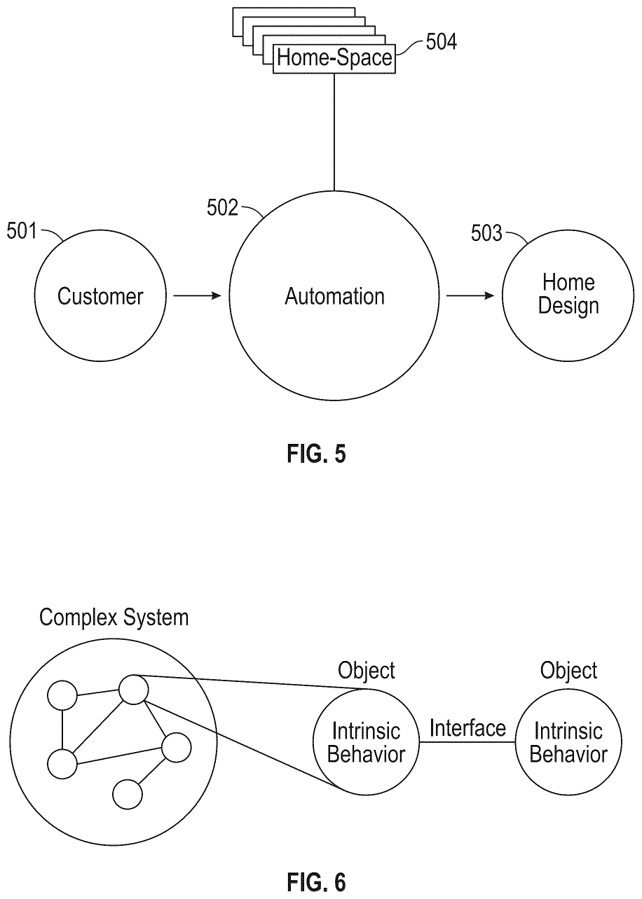

FIG. 4 demonstrates a straightforward automation of the process shown in previous diagrams. Here, software agents or applications programmed in controller 401 can replace human experts at stages 201-207 of the design process. As explained above, a downside of this approach is that it can fail to adapt to changes in scope or operational scenarios, and replacing human expertise with software agents may be complex and expensive given the number of experts typically required in the building design process. FIG. 5 illustrates the use of sentient building blocks (i.e. virtual building elements) 504 to partially or fully automate a building design process, which can eliminate the need for replacement of experts in the automation of a building design process. Each block 504 can incorporate the necessary expertise within itself. Accordingly, beginning with the customer 501, various steps of the design process can be consolidated or combined at step 502 through the use of sentient building blocks (i.e. virtual building elements) 504, leading ultimately to a complete home design 503.

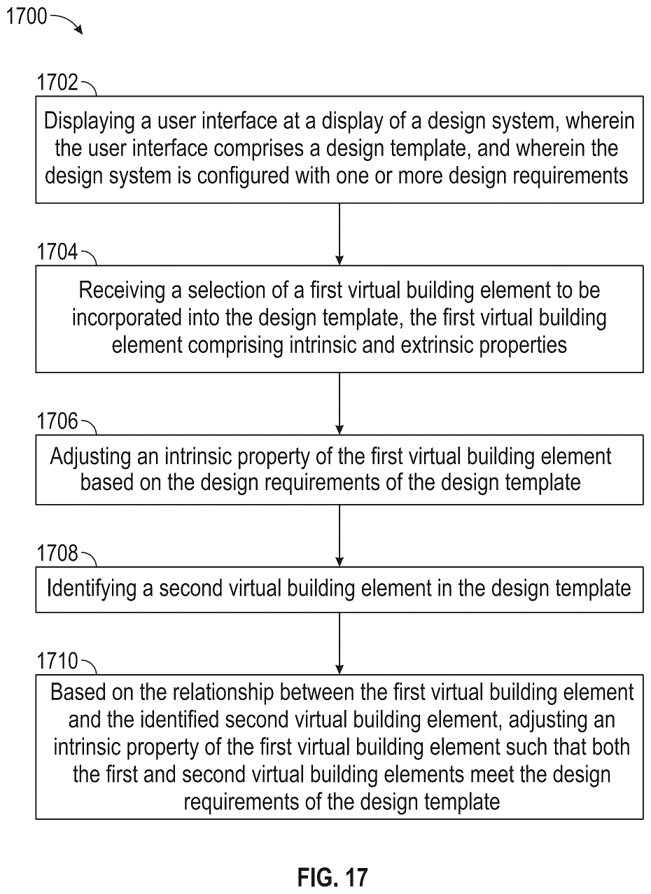

A method 1700 for designing a building incorporating some of the automation principles of FIG. 5 is illustrated in FIG. 17. As described, method 1700 can include any of steps 1702-1710 in any order. In some embodiments, one or more of steps 1702-1710 may be repeated any given number of times (e.g. until a compliant building design is achieved) or one or more steps may be omitted from method 1700. In some embodiments, one or more of the steps of method 1700 can be performed automatically by a design system. In some embodiments, one or more of the steps of method 1700 can be performed manually by a user instead of, or in addition to, the automatic performance of one or more other steps.

At step 1702, the method may include displaying a user interface at a display of a design system, wherein the user interface comprises a design template, and wherein the design system or template is configured with one or more design requirements. In some embodiments, the system may be system 1600 described above, and the user interface may be user interface 1612 described above.

As described above, these design requirements may include, for example, architectural requirements, mechanical, electrical, and plumbing (MEP) requirements, building codes, or zoning requirements. Architectural requirements may include, for example, structural requirements, aesthetic requirements (such as a preference by the user or neighborhood as to how the building should look), and/or requirements of building materials. Examples of mechanical, electrical, and plumbing (MEP) requirements can include heating, ventilation, and air conditioning (HVAC) requirements, or requirements for routing and connecting electrical wires, conduits, or pipes. In some embodiments, one or more of these design requirements may come from building codes including occupancy requirements, fire codes, and so on. In some embodiments, the building codes and/or zoning requirements may be specific to a local area in which the building is to be built, or they may be specific to a state in which the building is to be built, or they may be specific to a country in which the building is to be built. The virtual building elements and/or the design template can be programmed with logic encompassing these design requirements as logic rules using an object-oriented programming approach, as described above. In addition, the virtual building element and/or design templates can be continuously updated either by a user or automatically to stay up to date with design requirements as various regulations or laws may change over time.

At step 1704, method 1700 may include receiving a selection of a first virtual building element to be incorporated into the design template. In some embodiments, the user's selection is received at a user interface, such as user interface 1612 described above. In some embodiments, the virtual building elements to be selected by the user can include various types of rooms, such as a bedroom, a kitchen, a living room, a dining room, a bathroom, a basement, a corridor, or a garage. In some embodiments, the virtual building clement may represent a modular building clement having one or more modular, pre-constructed wall panels, ceiling panels, and the like. In some embodiments, the building may have multiple floors.

In some embodiments, the virtual building clement may have one or more intrinsic properties which can be determined individually with respect to the virtual building element itself without regard to the relationships between multiple virtual building elements in the design template. The intrinsic properties may include dimensions, positioning, and/or sub-elements located within the first virtual building clement. The dimensions of the first virtual building clement may be 2D or 3D dimensions. The position of the virtual building element in the design template may be defined by an orientation of the virtual building element (i.e. north-facing or a degree of rotation relative to an axis) or a default location in the design template notwithstanding other building elements in the design template.

In some embodiments, the intrinsic properties can include the dimensions, locations, and other properties of one or more sub-elements located within the virtual building clement, such as windows, walls, doors, or MEP components such as an HVAC component (e.g. an A/C unit, furnace, etc.), a plumbing component (e.g. a pipe or a plumbing fixture), an electrical component (e.g. a wire, a breaker panel, an outlet, or a light fixture), or a data component (e.g. data cables or ethernet ports). In some embodiments, the virtual design template may include more than one virtual building element of a given class (e.g. multiple bedrooms or bathrooms).

In some embodiments, the design template may have one or more extrinsic properties that are defined and adjusted based on the relationship between the virtual building element and one or more other virtual building elements in the building design. For example, the extrinsic properties may include extrinsic properties comprising a shear wall potential, an MEP system, an overall layout of virtual building elements in the design template, or combinations thereof.

In some embodiments, method 1700 can include, at step 1706, adjusting intrinsic properties of the first virtual building element based on the design requirements of the design template. In some embodiments, adjusting intrinsic properties of the first building element comprises resizing the first virtual building element, rotating the first virtual building element, adding, removing, and/or changing a location of a sub-element within the first virtual building element, or combinations thereof.

Method 1700 may allow for the partial or complete automation of the adjustment of the intrinsic parameters. For example, there may be one or more intrinsic properties that are automatically adjusted by the system, while other intrinsic properties may be adjusted by a user through the user interface. The intrinsic properties can be adjusted by the system executing the intrinsic operations programmed into the virtual design template or the virtual building element, as described above. The intrinsic properties can be adjusted to comply with various design requirements programmed into the virtual design template or the virtual building element, such as architectural considerations, MEP considerations, building codes, and zoning requirements. Thus, a user may not need to consult various experts during the design process to obtain this information and ensure a compliant design.

In some embodiments, method 1700 may include identifying a second virtual building element in the design template at step 1708. This may be any other virtual building element in the design template in addition to the first virtual building element that is selected by the user at the user interface. In some embodiments, the second virtual building element may also include one or more intrinsic properties such as those listed above. In some embodiments, one or more steps of the method can be repeated for any number of virtual building elements added to the design template.

In some embodiments, at step 1710, the method may include, based on the relationship between the first virtual building clement and the identified second virtual building element, adjusting intrinsic properties of the first virtual building element such that both the first and second virtual building elements meet the design requirements of the design template. Adjusting the intrinsic properties may mean, for example, resizing the first virtual building element, rotating the first virtual building element, adding, removing, and/or changing a location of a sub-element within the first virtual building element, or other adjustments that are made to the virtual building element itself. In some embodiments, a similar step may be performed on the second virtual building element to adjust its intrinsic properties, such that both the first and the second virtual building elements comply with the design requirements.

In some embodiments, method 1700 may include reviewing the building design for compliance with the design requirements. For example, a user may verify whether or not the design template complies with the one or more design requirements by consulting an expert. Although the system is configured to output a compliant design template, this step may optionally be performed as a second check. In some embodiments, method 1700 can further include constructing the building based on the entire design template or a portion of the design template. In this manner, the systems and methods described herein can be used to design an entire building or an individual room within the building depending on the needs of a particular design case.

In some embodiments, an exemplary workflow or method incorporating the use of use of sentient building blocks (i.e. virtual building elements) may be performed from the perspective of a single “space” or building block. In some embodiments, an exemplary workflow may include an initialization step, in which the sentient building block (e.g., virtual building element such as a kitchen) is selected for the design. In some embodiments, an exemplary workflow may include an intrinsic adjustment step, in which the building block (i.e. virtual building element) can adjust its intrinsic properties based on design requirements, such as dimensions and included elements (e.g., window, electrical outlets, door, closet). In some embodiments, an exemplary workflow may include an inter-block interaction step, in which the building block can identify its neighboring blocks (e.g., living room, dining room). In some embodiments, an exemplary workflow may include intrinsic or extrinsic adjustment, in which the building block adjusts its properties based on its relationships with neighboring blocks. This could involve altering dimensions, removing or adding walls, and so on. In some embodiments, an exemplary workflow may include a self-review step, in which the building block checks its own design, including adaptations made due to intrinsic properties and relationships with other blocks. In some embodiments, an exemplary workflow may include a step in which the building block determines if changes are needed. If changes are needed, the intrinsic adjustment or extrinsic adjustment steps can be repeated as needed. In some embodiments, if no changes are needed, an exemplary workflow may include an integration step, in which the building block can integrate itself into the overall design.

The systems and methods described herein can enable a non-linear, concurrent development process, breaking away from the traditional sequential model. By allowing building blocks to resolve multiple disciplinary issues simultaneously, the systems and methods described herein can streamline the design process, reduce time delays, and improve overall efficiency.

The adaptability of the systems and methods described herein can efficiently manage the common design variations found in modular construction. This adaptability can reduce the delays and costs associated with handling such variations in traditional design processes.

The systems and methods described herein can integrate automation into the design process, eliminating the need for human experts at every stage. This can result in a significant reduction in costs and time investment, making the construction process more economical and efficient.

The virtual design elements, or “building blocks” programmed in the user interface, may be “sentient” in that they are designed to be aware of and compliant with applicable building codes and regulations. This can simplify the process of ensuring code compliance and acquiring necessary permits, reducing the associated complexities and time delays.

The systems and methods described herein can allow for the efficient management of the interactions between different building blocks, taking into account their relationships and interfaces. This can result in better coordination and collaboration between different elements of the design, enhancing the overall quality of the construction.

In summary, the systems and methods described herein can provide an efficient approach to building design and construction, particularly for modular or prefabricated structures, offering significant improvements over existing technologies and methodologies.

The ability to automate many aspects of the design process and adapt to design variations, the systems and methods described herein can be a valuable tool for architects and designers. It can help them create efficient and code-compliant designs with a significant reduction in time and cost. Developers who engage in large-scale construction projects, particularly those involving modular or prefabricated structures, may find the systems and methods described herein to be beneficial. The systems and methods described herein can streamline the development process, ensure compliance with codes and regulations, and lead to substantial cost savings. Companies involved in the actual construction of buildings can use the systems and methods described herein to reduce errors, improve efficiency, and ensure that the structures they build are compliant with all necessary regulations.

Individuals planning to build their own homes or develop their land can use the systems and methods described herein to simplify the design process, reduce costs, and ensure that their construction project meets all necessary codes and regulations. Those involved in the development of building design software could integrate the systems and methods described herein into their products to enhance their capabilities and provide a more efficient and adaptable tool for their customers. City planners, zoning departments, and other government entities can use the systems and methods described herein to ensure that proposed construction projects meet all necessary codes and are compatible with the surrounding environment. In summary, the systems and methods described herein can be a valuable tool for a wide range of individuals and businesses involved in the building design and construction process.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method of designing a building using a design system, the method comprising:
displaying a user interface at a display, wherein the user interface comprises a design template, wherein the design template is configured with design requirements comprising architectural requirements, mechanical, electrical, and plumbing (MEP) requirements, building codes, and/or zoning requirements;
receiving a selection of a first virtual building element to be incorporated into the design template;
adjusting an intrinsic property of the first virtual building element based on the design requirements of the design template, wherein the intrinsic property comprises dimensions, positioning, and/or sub-elements located within the first virtual building element;
identifying a second virtual building element in the design template; and
based on the relationship between the first virtual building element and the identified second virtual building element, adjusting an intrinsic property of the first virtual building element such that both the first and second virtual building elements meet the design requirements of the design template.

2. The method of claim 1, wherein adjusting an intrinsic property of the first virtual building element comprises resizing the first virtual building element, rotating the first virtual building element, adding, removing, and/or changing a location of a sub-element within the first virtual building element, or combinations thereof.

3. The method of claim 1, further comprising adjusting an intrinsic property of the second virtual building element such that both the first and second virtual building elements meet the design requirements.

4. The method of claim 3, wherein adjusting an intrinsic property of the second virtual building element comprises resizing the second virtual building element, rotating the second virtual building element, adding, removing, and/or changing a location of a sub-element within the second virtual building element, or combinations thereof.

5. The method of claim 1, wherein the sub-element comprises a window, a wall, a door, an MEP component, a modular building element located within the first or second building element, or combinations thereof.

6. The method of claim 5, wherein the MEP component comprises an HVAC component, a plumbing component, an electrical component, a data component, or combinations thereof.

7. The method of claim 1, wherein the first or second virtual building element comprises a bedroom, a kitchen, a living room, a dining room, a bathroom, a basement, a corridor, a garage, or combinations thereof.

8. The method of claim 1, further comprising adjusting an extrinsic property of the design template to meet the design requirements, wherein the extrinsic property comprises a shear wall potential, an MEP system, an overall layout of multiple virtual building elements in the design template, or combinations thereof.

9. The method of claim 8, wherein adjusting the extrinsic property comprises aligning windows, adjusting MEP routing, or changing an overall layout of multiple virtual building elements in the design template.

10. The method of claim 1, wherein the design template is a floor plan, a blueprint, and/or a skeleton of a house, a building, or a neighborhood.

11. The method of claim 1, further comprising constructing the building based on the design template.

12. A design system comprising:
a display;
one or more processors; and
memory storing instructions configured to be executed by the one or more processors to cause the design system to:
display a user interface, wherein the user interface comprises a design template, wherein the design template is configured with design requirements comprising architectural requirements, mechanical, electrical, and plumbing (MEP) requirements, building codes, and/or zoning requirements;
receive a selection of a first virtual building element to be incorporated into the design template;
adjust an intrinsic property of the first virtual building element based on the design requirements of the design template, wherein the intrinsic property comprises dimensions, positioning, and/or sub-elements located within the first virtual building element;
identify a second virtual building element in the design template; and
based on the relationship between the first virtual building element and the identified second virtual building element, adjust an intrinsic property of the first virtual building element such that both the first and second virtual building elements meet the design requirements of the design template.

13. The design system of claim 12, wherein adjusting an intrinsic property of the first building element comprises resizing the first virtual building element, rotating the first virtual building element, adding, removing, and/or changing a location of a sub-element within the first virtual building element, or combinations thereof.

14. The design system of claim 12, further comprising adjusting an intrinsic property of the second virtual building element such that both the first and second virtual building elements meet the design requirements.

15. The design system of claim 14, wherein adjusting an intrinsic property of the second virtual building element comprises resizing the second virtual building element, rotating the second virtual building element, adding, removing, and/or changing a location of a sub-element within the second virtual building element, or combinations thereof.

16. The design system of claim 12, wherein the sub-elements comprise a window, a wall, a door, an MEP component, a modular building element located within the first or second building element, or combinations thereof.

17. The design system of claim 16, wherein the MEP component comprises an HVAC component, a plumbing component, an electrical component, a data component, or combinations thereof.

18. The design system of claim 12, wherein the first or second virtual building element comprises a bedroom, a kitchen, a living room, a dining room, a bathroom, a basement, a corridor, a garage, or combinations thereof.

19. The design system of claim 12, further comprising adjusting an extrinsic property of the design template to meet the design requirements, wherein the extrinsic property comprises a shear wall potential, an MEP system, an overall layout of virtual building elements in the design template, or combinations thereof.

20. The design system of claim 19, wherein adjusting the extrinsic property comprises aligning windows, adjusting MEP routing, or changing an overall layout of virtual building elements in the design template.

21. The design system of claim 12, wherein the design template is a blueprint, a floor plan, and/or a skeleton of a house, a building, or a neighborhood.

22. A non-transitory computer readable storage medium storing one or more programs, the one or more programs comprising instructions, which, when executed by a design system, cause the design system to:
display a user interface at a display, wherein the user interface comprises a design template, wherein the design template is configured with design requirements comprising architectural requirements, mechanical, electrical, and plumbing (MEP) requirements, building codes, and/or zoning requirements;
receive a selection of a first virtual building element to be incorporated into the design template;
adjust an intrinsic property of the first virtual building element based on the design requirements of the design template, wherein the intrinsic property comprises dimensions, positioning, and/or sub-elements located within the first virtual building element;
identify a second virtual building element in the design template; and
based on the relationship between the first virtual building element and the identified second virtual building element, adjust an intrinsic property of the first virtual building element such that both the first and second virtual building elements meet the design requirements of the design template.
